(19) United States
(12) Patent Application Publication
(10) Pub. No.: US 2015/0317944 A1
(43) Pub. Date: Nov. 5, 2015

(54) MOBILE DEVICE BASED COLOR MANAGEMENT OF DIGITAL DISPLAYS

(71) Applicant: QUALCOMM Incorporated, San Diego, CA (US)

(72) Inventors: Reza Safaee-Rad, Etobicoke (CA); Milivoje Aleksic, San Diego, CA (US)

(73) Assignee: QUALCOMM Incorporated, San Diego, CA (US)

(21) Appl. No.: 14/269,002

(22) Filed: May 2, 2014

(51) Int. Cl. G09G 5/02; G06T 1/20

(52) U.S. Cl. CPC G09G 5/02; G06T 1/20; G09G 2370/04; G09G 2360/145; G09G 2320/029; G09G 2320/0242; G09G 2320/0693; G09G 2320/0666; G09G 2320/0673; G09G 2320/0209; G09G 2320/066

(57) ABSTRACT

Systems and methods for using a mobile device to manage the color of a digital display on a target device are disclosed. The mobile device can associate with the target device to determine compatibility and identify the display architecture of the target device. The mobile device can further communicate with the target device to display test patterns on the target device that are then sensed by a miniature color sensor on the mobile device. The mobile device then analyzes the color attributes of the test patterns and generates color management data that includes adjustments to be made to the display architecture of the target device. The target device may then receive the color management data and adjust its display architecture accordingly.

### BACKGROUND

1. Field of the Invention

This disclosure relates generally to color management of digital displays. In particular, features for managing color in digital displays with mobile device based systems and methods are disclosed.

2. Description of the Related Art

With the proliferation of digital displays and the concomitant growth in applications of such displays, the quality of the pictures shown on those displays has become increasingly important. Digital displays are now used on televisions, telephones, computers, stadium big screens, navigation screens, medical viewing monitors, etc. Further, such displays are used for a multitude of purposes, including viewing videos and displaying images for entertainment, pleasure, business, design, medicine, etc.

In many applications that use digital displays, the quality of the picture is paramount. For example, a particular color may be desired for interior design. An interior designer may view the colors on a digital display before ordering materials with that color. Therefore, it is important that the color shown on the display is an accurate representation of the color of the material.

The quality of a picture on a digital display may be improved by managing the color, for instance by calibration. Conventional systems and methods for managing color of digital displays are used and performed in quality assessment facilities. Digital displays are typically calibrated and tuned in the laboratory after leaving the production line. Once the display has left the laboratory, further calibration and tuning is inconvenient and time intensive as the display must be brought back to the laboratory. Further, the equipment for performing the calibration and tuning imposes restraints on the process. Typically, a measurement instrument, such as a colorimeter, records the measurements from a display and transmits the measurement data to a desktop computer, which then analyzes the data and transmits instructions to a separate panel driver, which then adjusts the display accordingly. Therefore, bulky equipment must be present in order to calibrate and generally manage the color of the display.

It is thus difficult with conventional systems and methods to perform color management of digital displays repeatedly and in a convenient and timely manner without the need for such bulky equipment and facilities.

### SUMMARY

The embodiments disclosed herein each have several aspects no single one of which is solely responsible for the disclosure's desirable attributes. Without limiting the scope of this disclosure in any way, certain prominent features will now be briefly discussed, and such features may appear together or separately in one or more embodiments. After considering this discussion, and particularly after reading the section entitled “Detailed Description,” one will understand how the features of the embodiments described herein provide advantages over existing digital display calibration systems and methods.

Various embodiments of systems and methods disclosed herein manage display and color characteristics of a digital display using a mobile device. Using such methods and/or systems, a color management process can be accomplished quickly, for example, in a matter of minutes or quicker, with only a mobile device and a compatible target device. In some embodiments, the mobile device identifies and confirms compatibility with the display processing pipe architecture (also referred to as “display architecture”) of the target device, such as a cell phone or tablet. Based on the display processing pipe architecture of the target device, the mobile device prepares test display information to be sent to the target device to cause the target device to display test patterns associated with the test display information. The mobile device then senses and measures color attributes of the target device test patterns with a color sensor and generates color management data based on analysis of the color attributes. The color management data is further determined based on the architecture and the components of the architecture to be adjusted. The mobile device can transmit the color management data to the target device which uses the data to adjust the corresponding components of the display processing pipe architecture. Multiple components of the display processing pipe architecture can be managed corresponding to various color management parameters, including, for example, white point correction, gamma correction, tone adjustment, color crosstalk correction, gamut expansion, gamut reduction and mixed gamut mapping. Further, the system allows for updates to the software of either device, to include, for example, enhanced algorithms or new databases to be used in subsequent color management processes. Thus the color management may be done repeatedly and frequently on a regular basis. This allows for use of the latest software and databases, and it further addresses aging issues of display panels, such as color shifting or aging of the blue primary on OLED display panels. The color management may also be a self-management system or process involving only one of the devices, such as a single mobile device with an optical element or an external colorimeter. Finally, besides color management of digital displays, the features disclosed herein may also be used to verify colors in other contexts, including but not limited to wall or fabric color in interior design, skin tone color in cosmetics, and skin color in medicine.

In one aspect, several embodiments of a mobile device based system for managing color of a display screen on a target device are disclosed. In some embodiments, the system comprises a communications subsystem configured to communicate with the target device, a color sensor configured to sense one or more color attributes of display information presented on the display screen, and a processor configured to execute a set of instructions to perform a method. In some embodiments, the method comprises identifying a display processing pipe architecture of the target device, sensing the one or more color attributes of display information presented on the display screen, determining color management data based in part on the one or more color attributes and the identified display processing pipe architecture of the target device, and transmitting the color management data to the target device. In some embodiments, the method further comprises configuring the display processing pipe architecture of the target device.

In some embodiments, determining color management data comprises retrieving, from a memory component of the mobile device, calibration information based on the identified display architecture of the target device, wherein determining the color management data is based in part on the retrieved calibration information. In some embodiments, the color management data is configured to be received by the target device and to cause the display architecture of the target device to be modified based on the received color management data. In some embodiments, the method further comprises transmitting test display information to the target device from the mobile device, wherein the test display information indicates at least one test pattern to present on the display screen of the target device.

In some embodiments, the test display information is configured to be received by the target device and to cause the target device to display one or more test patterns on the display screen of the target device, wherein the one or more test patterns are based on the received test display information.

In some embodiments, the one or more color attributes includes information related to white point correction, gamma correction, tone adjustment, color crosstalk correction, gamut expansion, gamut reduction, or mixed gamut mapping. In some embodiments, modifying the display architecture of the target device comprises programming one or more components of the display architecture of the target device using the color management data. In some embodiments, one or more components of the display architecture of the target device comprises a white point, gamma, or tone parameter.

In another aspect, several embodiments are disclosed for a mobile device based system for managing color of a display screen on a target device, where the system comprises means for identifying a display processing pipe architecture of the target device, means for sensing the one or more color attributes of display information presented on the display screen, means for determining color management data based in part on the one or more color attributes and the identified display processing pipe architecture of the target device, and means for transmitting the color management data to the target device. In some embodiments, the system further comprises means for configuring the display processing pipe architecture of the target device.

In some embodiments, the means for determining comprises means for retrieving, from a memory component of the mobile device, calibration information based on the identified display processing pipe architecture of the target device, wherein determining the color management data is based in part on the retrieved calibration information.

In some embodiments, the color management data is configured to be received by the target device and to cause the display processing pipe architecture of the target device to be modified based on the received color management data.

In some embodiments, the system further comprises means for transmitting test display information to the target device from the mobile device, wherein the test display information is configured to be received by the target device and to cause the target device to display one or more test patterns on the display screen of the target device, wherein the one or more test patterns are based on the received test display information.

In some embodiments, the one or more color attributes includes information related to white point correction, gamma correction, tone adjustment, color crosstalk correction, gamut expansion, gamut reduction, or mixed gamut mapping.

In some embodiments, modifying the display architecture of the target device comprises programming one or more components of the display architecture of the target device using the color management data.

In a further aspect, several embodiments are disclosed for a method of managing color of a display screen on a target device. In some embodiments, the method comprises identifying, with a mobile device, a display architecture of the target device, sensing, with the mobile device, one or more color attributes of display information presented on the display screen, determining, with the mobile device, color management data based in part on the one or more color attributes and the identified display architecture of the target device, and transmitting the color management data to the target device.

In some embodiments, the method further comprises programming the display architecture of the target device.

In some embodiments, determining color management data comprises retrieving, from a memory component of the mobile device, calibration information based on the identified display architecture of the target device, wherein determining the color management data is based in part on the retrieved calibration information.

In some embodiments, the color management data is configured to be received by the target device and to cause the display architecture of the target device to be programmed based on the received color management data.

In some embodiments, the method further comprises transmitting test display information to the target device from the mobile device, wherein the test display information indicates at least one test pattern to present on the display screen of the target device.

In some embodiments, the test display information is configured to be received by the target device and to cause the target device to display one or more test patterns on the display screen of the target device, wherein the one or more test patterns are based on the received test display information.

In some embodiments, the one or more color attributes includes information related to white point correction, gamma correction, tone adjustment, color crosstalk correction, gamut expansion, gamut reduction, or mixed gamut mapping.

In some embodiments, modifying the display architecture of the target device comprises programming one or more components of the display architecture of the target device using the color management data.

In another aspect, several embodiments are disclosed of a non-transient computer readable medium configured to store instructions that when executed by a processor perform a method for color management of a display screen on a target device. In some embodiments, the method comprises identifying a display architecture of the target device, sensing the one or more color attributes of display information presented on the display screen, determining color management data based in part on the one or more color attributes and the identified display architecture of the target device, and transmitting the color management data to the target device.

In some embodiments, the method further comprises configuring the display architecture of the target device.

In some embodiments, determining comprises retrieving, from a memory component of the mobile device, calibration information based on the identified display architecture of the target device, wherein determining the color management data is based in part on the retrieved calibration information.

In some embodiments, the color management data is configured to be received by the target device and to cause the display architecture of the target device to be modified based on the received color management data.

In some embodiments, the method further comprises transmitting test display information to the target device from the mobile device, wherein the test display information indicates at least one test pattern to present on the display screen of the target device.

In some embodiments, modifying the display architecture of the target device comprises programming one or more components of the display architecture of the target device using the color management data.

In a further aspect, several embodiments for a mobile device based system for managing color of a display screen on the mobile device are disclosed. In some embodiments, the system comprises a color sensor configured to sense one or more color attributes of display information presented on the display screen and the mobile device. In some embodiments, the mobile device comprises a display architecture and a processor configured to execute a set of instructions to perform a method. In some embodiments, the method comprises configuring the display architecture, receiving data related to the one or more color attributes of display information presented on the display screen, determining color management data based on the one or more color attributes and type of display architecture in the mobile device, and modifying the display architecture based on the color management data.

In some embodiments, the system further comprises an optical element configured to reflect the display information presented on the display screen, the mobile device comprises the color sensor, and the method further comprises sensing the one or more color attributes of display information presented on the display screen as reflected by the optical element. The optical element may also reproduce the display information such that the display information may be sensed as reproduced by the optical element for use in managing the color of the display screen. Therefore, the display information may be reflected, reproduced, mimicked, or otherwise acted upon by the optical element to accurately indicate the display information presented on the display screen.

In some embodiments, the optical element includes a reflective surface, for example a mirror or other such reflective surface. The optical element may therefore be any object that is reflective, such as a metallic or other object with a mirror finish on the surface.

In some embodiments, the mobile device further comprises a communications subsystem, and the color sensor is separate from the mobile device and is configured to transmit to the mobile device the data related to the sensed color attributes of the display information presented on the display screen.

In some embodiments, the color sensor is a colorimeter.

In some embodiments, the method further comprises retrieving, from a memory component of the mobile device, test display information based on the display architecture, and the test display information indicates at least one test pattern to present on the display screen of the mobile device.

In some embodiments, the method further comprises presenting at least one test pattern on the display screen of the mobile device, and the at least one test pattern is based on the test display information.

In some embodiments, the one or more color attributes includes information related to white point correction, gamma correction, tone adjustment, color crosstalk correction, gamut expansion, gamut reduction, or mixed gamut mapping.

In some embodiments, modifying the display architecture of the mobile device comprises programming one or more components of the display architecture of the mobile device using the color management data.

In some embodiments, the one or more components of the display architecture of the mobile device comprises a white point, gamma, or tone parameter.

In another aspect, several embodiments for a mobile device based system for managing color of a display screen on the mobile device are disclosed. In some embodiments, the system comprises means for sensing one or more color attributes of display information presented on the display screen and a mobile device. In some embodiments, the mobile device comprises means for processing display information, means for configuring the means for processing display information, means for receiving data related to the one or more color attributes of display information presented on the display screen, means for determining color management data based on the one or more color attributes and type of means for processing display information in the mobile device, and means for modifying the means for processing display information based on the color management data.

In some embodiments, the system further comprises means for reflecting, mimicking, or otherwise reproducing or indicating, the display information presented on the display screen, and the mobile device comprises the means for sensing.

In some embodiments, the mobile device further comprises means for communicating, and the means for sensing is separate from the mobile device and is configured to transmit to the mobile device the data related to the sensed color attributes of the display information presented on the display screen.

In some embodiments, the mobile device further comprises means for retrieving, from a memory component of the mobile device, test display information based on the means for processing display information, and the test display information indicates at least one test pattern to present on the display screen of the mobile device.

In some embodiments, the mobile device further comprises means for presenting at least one test pattern on the display screen of the mobile device, and the at least one test pattern is based on the test display information.

In some embodiments, the one or more color attributes includes information related to white point correction, gamma correction, tone adjustment, color crosstalk correction, gamut expansion, gamut reduction, or mixed gamut mapping.

In a further aspect, several embodiments of a method of managing color of a display screen on a mobile device having a display architecture are disclosed. In some embodiments, the method comprises sensing one or more color attributes of display information presented on the display screen, configuring the display architecture, receiving data related to the one or more color attributes of display information presented on the display screen, determining color management data based on the one or more color attributes and type of display architecture in the mobile device, and modifying the display architecture based on the color management data.

In some embodiments, the method further comprises reflecting, mimicking, or otherwise reproducing or indicating with an optical element the display information presented on the display screen, and sensing the one or more color attributes of display information presented on the display screen as reflected or otherwise reproduced by the optical element, wherein the mobile device comprises the color sensor.

In some embodiments, the method further comprises sensing the one or more color attributes of display information presented on the display screen, and transmitting to the mobile device the data related to the sensed color attributes of the display information presented on the display screen, wherein the color sensor is separate from the mobile device.

In some embodiments, the method further comprises retrieving, from a memory component of the mobile device, test display information based on the type of display architecture, and the test display information indicates at least one test pattern to present on the display screen of the mobile device.

In some embodiments, the method further comprises presenting the at least one test pattern on the display screen of the mobile device, and the at least one test pattern is based on the test display information.

In some embodiments, the one or more color attributes includes information related to white point correction, gamma correction, tone adjustment, color crosstalk correction, gamut expansion, gamut reduction, or mixed gamut mapping.

In some embodiments, modifying the display architecture of the mobile device comprises programming one or more components of the display architecture of the mobile device using the color management data.

In some embodiments, the one or more components of the display architecture of the mobile device comprises a white point, gamma, or tone parameter.

In another aspect, several embodiments are disclosed for a non-transient computer readable medium configured to store instructions that when executed by a processor perform a method for color management of a display screen on a mobile device having a display architecture. In some embodiments, the method comprises sensing one or more color attributes of display information presented on the display screen, configuring the display architecture, receiving data related to the one or more color attributes of display information presented on the display screen, determining color management data based on the one or more color attributes and type of display architecture in the mobile device, and modifying the display architecture based on the color management data.

In some embodiments, the method further comprises reflecting, mimicking, or otherwise reproducing or indicating with an optical element the display information presented on the display screen, and sensing the one or more color attributes of display information presented on the display screen as reflected or otherwise reproduced by the optical element, wherein the mobile device comprises the color sensor.

In some embodiments, the method further comprises sensing the one or more color attributes of display information presented on the display screen, and transmitting to the mobile device the data related to the sensed color attributes of the display information presented on the display screen, wherein the color sensor is separate from the mobile device.

In some embodiments, the method further comprises retrieving, from a memory component of the mobile device, test display information based on the type of display architecture, and the test display information indicates at least one test pattern to present on the display screen of the mobile device.

In some embodiments, the method further comprises presenting the at least one test pattern on the display screen of the mobile device, and the at least one test pattern is based on the test display information.

In some embodiments, modifying the display architecture of the mobile device comprises programming one or more components of the display architecture of the mobile device using the color management data.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated and make part of this disclosure.

FIGS. 1A-1B show perspective views of embodiments of a mobile device being used to manage the color of a display screen on a target device.

FIG. 2A shows a perspective view of an embodiment of a target device calibrating itself by using an optical element.

FIG. 2B shows a perspective view of an embodiment of a target device calibrating itself by using an external color sensor.

FIG. 3 shows a block diagram of an embodiment of the mobile device of FIGS. 1A-1B.

FIG. 4A shows a block diagram of an embodiment of the target device of FIGS. 1A-2B having a display processing pipe architecture.

FIG. 4B shows a block diagram of an embodiment of the display architecture of the target device of FIGS. 1A-2B.

FIGS. 5A-5C show data tables with embodiments of settings that may be used by the mobile device of FIGS. 1A-1B and target device of FIGS. 2A-2B in configuring the display architecture of the target device.

FIG. 6A is a flowchart of an overview of an embodiment of a method performed by the mobile device of FIGS. 1A, 1B and 3 to manage the color of a display screen on a target device.

FIG. 6B is a flowchart of an embodiment of a detailed method performed by the mobile device of FIGS. 1A, 1B and 3 to manage the color of a display screen on a target device.

FIG. 6C is a flowchart of an embodiment of a method of retrieving calibration information for use in the method of FIGS. 6A-6B.

FIG. 6D is a flowchart of an embodiment of a method of configuring a display architecture of a target device for use in the method of FIGS. 6A-6B.

FIG. 6E is a flowchart of an embodiment of a method of determining and generating color management data for use in the method of FIGS. 6A-6B.

FIG. 7 is a flowchart of an embodiment of a method of modifying a display architecture of a target device performed by the target device of FIG. 4A.

FIG. 8 is a flowchart of an embodiment of a process of managing the color of a target device with a mobile device, the flowchart illustrating some interactions of certain methods, for example, as illustrated in FIGS. 6B and 7.

### DETAILED DESCRIPTION

The following detailed description is directed to certain specific embodiments of the development as described with reference to the accompanying figures. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments and examples of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the invention described herein.

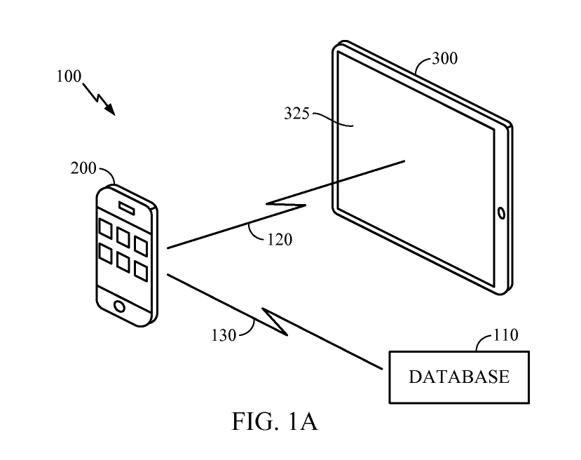

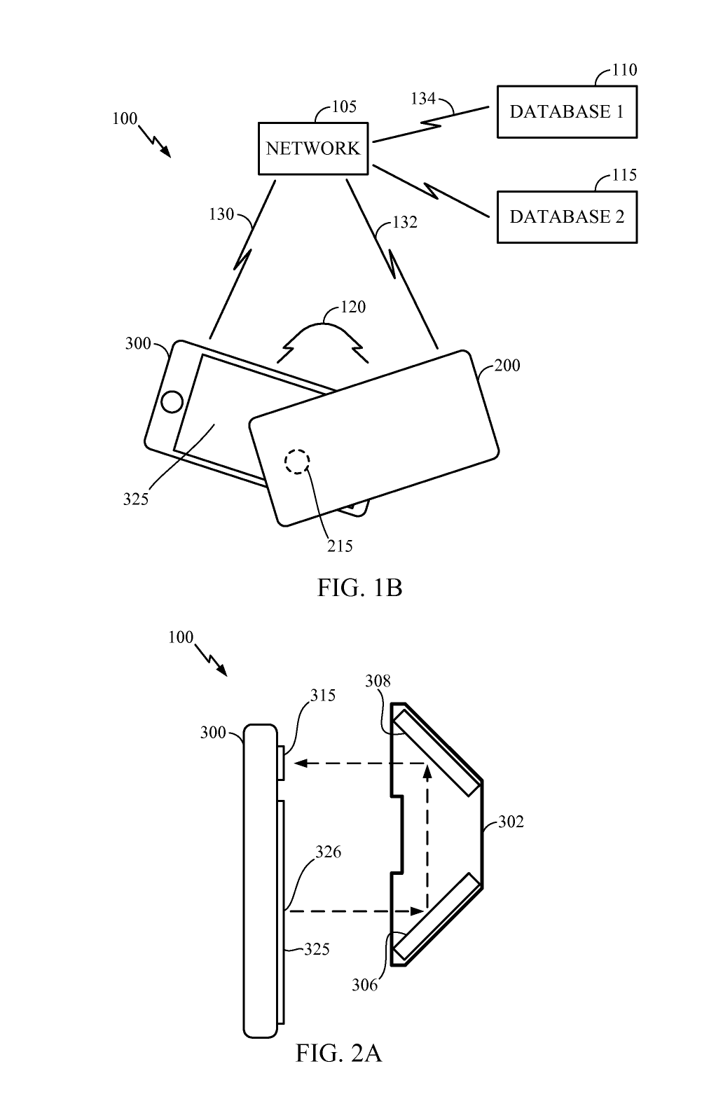

FIGS. 1A-1B show perspective views of embodiments of a system 100 for using a mobile device 200 to manage the color displayed on a target device 300. The mobile device 200 may be, for example, a mobile or cellular phone. The mobile device 200 may also be any number of portable devices, including for example, a computer, tablet, or personal digital assistant. The target device may be a device with a digital display, such as the tablet shown in FIG. 1A, or another mobile device such as the mobile phone as shown in FIG. 1B.

The devices in system 100 have an electronic communication connection 120 that allows the devices 200, 300 to communicate with each other. As shown, the communication connection 120 may be wireless so that the devices 200, 300 may communicate wirelessly. The wireless communication connection 120 may be via radio, local area network (LAN), Bluetooth, or any other wireless communication connection. The communication connection 120 may also be wired. The connection 120 may therefore be through a cable connecting the mobile device 200 to the target device 200. The communication connection 120 provides for exchange of data or other information between the devices 200, 300.

In FIG. 1B, the target device 300 includes a display screen 325. The screen 325 and associated components are configured to display visual content on the device 300. The screen 325 may be a digital or electronic display. The screen 325 may therefore be, in some embodiments, a digital display on a mobile phone, a tablet, a computer, or on any other device having a digital display.

As shown in FIG. 1B, the mobile device 200 includes a color sensor 215 (shown in dashed line as it is on the underside of the mobile device 200 facing the target device 300). The color sensor 215 senses, measures and/or recognizes colors, or color properties or color attributes, of surfaces or ambient lights. The color may be defined, for example, in terms of XYZ color coordinates. In some embodiments, the color sensor 215 is a red-green-blue (RGB) sensor that senses and/or measures color attributes. The sensor 215 may be a color filter array that captures incoming red, green and blue light components. The sensor 215 measures the colors rendered on the display screen 325 on the target device 300. Various patterns, images or other desired digital representations may be shown on the screen 325 and measured by the mobile device 200 with the color sensor 215.

As shown in FIGS. 1A-1B, the system 100 may also include various communication connections. As mentioned, the two devices 200, 300 may have a wireless communication connection 120. Further, the devices 200, 300 may have communication connections with external devices, networks, and/or databases. The mobile device 200 may have a communication connection 130 with a database 110. The database 110 may store and allow access to various parameters related to the system 100. In some embodiments, the database 110 includes information related to displaying, for example, display processing pipe architectures, software updates and/or related tasks. The mobile device 200 may connect to and access the database 110 directly, as shown in FIG. 1A, or indirectly through a network 105, as shown in FIG. 1B. The network 105 may be a cellular network. The network 105 may further be a series of networks connected to each other in order to provide access to the database 110. In some embodiments, the network 105, or the devices 200, 300 themselves, may connect with and access multiple databases, such as database 110 and separate database 115. In some embodiments, database 110 is stored on the one or more of the mobile device 200 or the target device 300.

The system 100 may include the devices 200, 300 in various positions and configurations relative to each other to account for ambient light. In some embodiments the mobile device 200 may be located in a fixed (or specified) position with respect to the target device 300. As shown in FIG. 1A, in some embodiments the mobile device 200 may be at a fixed (or specified) distance from the target device 300. The mobile device 200 may stay in this position while sensing the colors rendered on the display screen 325 of the target device 300. In some embodiments, the mobile device 200 is a few inches or feet from the target device 300. In some embodiments, the devices 200, 300 are separated by a certain distance while a particular ambient light is present. For instance, indoor lighting may be present such as that in a typical office or home. In such cases, the devices 200, 300 are at a fixed distance relative to each other and the relative positions of the devices 200, 300 does not change while the mobile device 200 is measuring the color of the target device 300.

In some embodiments, the devices 200, 300 are positioned so that ambient light does not affect the sensed light information, or that the effect of the ambient light on the sensed light information is minimal or is controlled. This may be done, for example, by placing the mobile device 200 and the target 300 out of direct sunlight and/or in a dimly lit environment. In some embodiments, the devices 200, 300 are placed close to each other. In some embodiments, the mobile device 200 is placed adjacent to the target device 300. As shown in FIG. 1B, the mobile device 200 may be placed on top of the target device 300, or vice versa. The devices 200, 300 may be placed in other positions, configurations and/or orientations that will allow for controlling or otherwise mitigating the effect of ambient light. For instance, the devices 200, 300 may be adjacent to each other in vertical positions, such as standing on end. The mobile device 200 may be positioned in any number of ways such that the color sensor 215 is in a position to measure from a close distance the colors rendered on the display screen 325 of the target device 300. In some embodiments, the color sensor 215 senses (or detects) light from a portion of the display screen 325 of the target device 300. By placing the mobile device 200 close or adjacent to the target device 300, the effect of ambient light is thus better controlled. In some embodiments, the devices 200, 300 may be placed adjacent to each other such that a dark room condition is simulated. In some embodiments, the devices 200, 300 may be placed adjacent to each other in a dark room.

In some embodiments, the target device 300 may be configured to manage its own color or otherwise calibrate itself. Any of the configurations mentioned herein with respect to the mobile device 200 and target device 300 may be used for self-color management or self-calibration by the mobile device 200 or the target device 300 and an optical element 302. For the sake of describing an example embodiment, the target device 300 will be used. In some embodiments, the target device 300 may be placed at a fixed distance from the optical element 302. In some embodiments, the target device 300 may be placed close to or adjacent to the optical element 302.

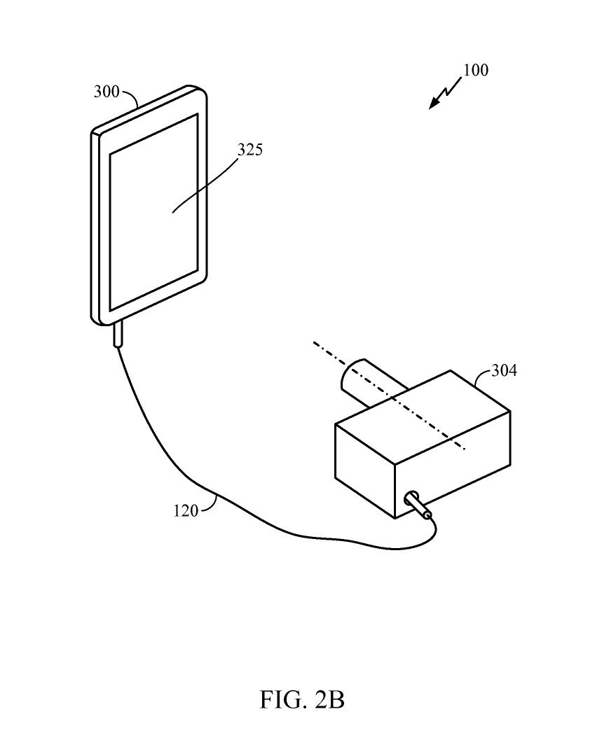

FIG. 2A depicts a self-calibration or self-color management embodiment of the system 100 including the target device 300 and an optical element 302. In some embodiments, the optical element 302 is a redirecting or reflective surface or surfaces, for example, the surface or surfaces of a mirror or mirrors. In some embodiments, the optical element 302 is one or more prisms. The optical element 302 may be any object capable of redirecting, reflecting or otherwise reproducing the display information presented on the display screen 325 with accurate representations of the color attributes of such display information. The optical element 302 may thus redirect, reflect, mimic, or otherwise reproduce or indicate the display information or colors rendered on the display screen 325. The colors rendered on the display screen 325 may therefore be visible in or on the optical element. A color sensor 315 on the target device 300 may then measure the information or colors displayed on the target device as redirected by the optical element 302.

As shown in FIG. 2A, the optical element 302 may include a first redirecting surface 306 and a second redirecting surface 308. In some embodiments, the optical element 302 may include more than two redirecting surfaces. The target device 300 may include the display screen 325 and color sensor 315. Further, the display screen 325 may have a center 326. In some embodiments, the center 326 coincides with the horizontal midpoint of the display screen 325. In some embodiments, the center 326 coincides with the vertical midpoint of the display screen 325. In some embodiments, the center 326 coincides with the horizontal and vertical midpoint of the display screen 325. In some embodiments, the center 326 is a region including the horizontal and/or vertical midpoint of the display screen 325. Further, the redirected display information may be display information redirected from all, most, or a portion of the center 326.

In some embodiments, the first redirecting surface 306 is aligned with the center 326 of the display screen 325. In some embodiments, the display information from the center 326 of the display screen 325 is directed away from the display screen 325 in a direction that is perpendicular to the display screen 325. The display information from the center 326 of the display screen 325 may be directed at the first redirecting surface 306. In some embodiments, the display information is directed along the arrow from the display screen 325 to the first redirecting surface 306.

The first redirecting surface 306 may be angled with respect to the display screen 325. In some embodiments, the first redirecting surface 306 is at a forty-five degree (45°) angle with respect to the display screen 325. In some embodiments, the first redirecting surface 306 is at an angle that is more or less than forty-five degrees (45°) with respect to the display screen 325.

The first redirecting surface 306 may redirect the display information that it receives. In some embodiments, the first redirecting surface 306 redirects the display information in a direction different than the direction whence it received the display information. As shown, the first redirecting surface 306 may redirect the display information at an angle of about forty-five degrees (45°). In some embodiments, the display information is redirected by the first redirecting surface 306 to the second redirecting surface 308. As shown, the display information is redirected along the arrow from the first redirecting surface 306 to the second redirecting surface 308.

The second redirecting surface 308 of the optical element 302 may be aligned with the color sensor 315 of the target device 300. In some embodiments, the second redirecting surface 308 may be aligned with the center of the color sensor 315. In some embodiments, the second redirecting surface 308 may be aligned such that display information is redirected to the color sensor 315. In some embodiments, display information is redirected to the color sensor 315 in a direction that is parallel with an axis of the color sensor 315. In some embodiments, display information leaves the display screen 325 at a right angle to the display screen 325 and is redirected to the color sensor 315 in a direction that is parallel to the path of the information leaving the display screen 325. In some embodiments, the second redirecting surface 308 may be aligned such that display information from the center 326 of the display screen 325 that is redirected by the first redirecting surface 306 is redirected by the second redirecting surface 308 to the color sensor 315. As shown, display information from the center 326 of the display screen 325 is directed toward the first redirecting surface 306, which redirects the display information to the second redirecting surface 308, which redirects the display information to the color sensor 315. As shown, the redirecting surfaces 306, 308 of the optical element 302 are at forty-five degree (45°) angles with respect to the display screen 325. In some embodiments, the redirecting surfaces 306, 308 may be at other angles. Further, the redirected display information that is sensed and/or measured by the color sensor 315 may be display information redirected from all, most, or a portion of the center 326.

The optical element 302 may enclose the first and second redirecting surfaces 306, 308. In some embodiments, the optical element 302 covers or houses the first and second redirecting surfaces 306, 308. The optical element 302 may thus be closed to transfer or otherwise redirect light from the center 326 of the display screen 325 to the color sensor 315 with little or no influence or effect from, for example, stray, surrounding or ambient light. In some embodiments, the optical element 302 acts as a light pipe. The separation of the first redirecting surface 306 from the second redirecting surface 308 may be adjusted to accommodate different sizes of the target device 300 and/or different configurations and locations of the center 326 of the display screen 325 and the color sensor 315. As illustrated in FIG. 2A, the first redirecting surface 306 may be vertically closer or farther from the second redirecting surface 308 to accommodate such different configurations associated with the target device 300. In some embodiments, the optical element 302 is adjustable. For example, the optical element 302 may be lengthened or shortened to allow for more or less separation, respectively, between the first redirecting surface 306 and the second redirecting surface 308.

As shown in FIG. 2B, in some embodiments the target device 300 may self-calibrate using an external color sensor 304. The color sensor 304 may be similar to the color sensor 215 or color sensor 315. In some embodiments, the color sensor 304 is a colorimeter. The color sensor 304 may be in communicating connection with the target device 300 by electronic communication connection 120. In some embodiments, the color sensor 304 is wirelessly connected to the target device 300. For instance, the color sensor 304 may be connected to the target device 300 by Bluetooth, Wi-Fi, etc. In some embodiments, the color sensor 304 is connected by wire to the target device 300. As shown in FIG. 2B, the color sensor 304 is connected to the target device 300 by a cable, such as USB cable or other suitable wire.

The external color sensor 304 may be used in the same manner as the color sensor 215 on the mobile device 200 to manage the color of the screen display 325 of the target device 300. The external color sensor 304 and target device 300 may also be positioned, oriented, or otherwise configured in the same manner as the embodiments that include the target device 300 and the mobile device 200, as well as the embodiments that include the target device 300 and the optical element 302. As shown, the colorimeter 304 may be aligned such that its axis is perpendicular to the display screen 325. In some embodiments, the colorimeter 304 may be aligned such that the axis intersects the center 326 (see FIG. 2A) of the display screen 326. It is understood that further discussion herein related to embodiments of the system 100 that include the target device 300 and the mobile device 200 apply to other embodiments that include, for example, the target device 300 and the optical element 302, the target device 300 and the external color sensor 304, etc. Therefore, discussion herein of color management in the context of two devices is not meant to exclude the ability of the target device 300 to self-calibrate, or to otherwise limit the scope of the present disclosure.

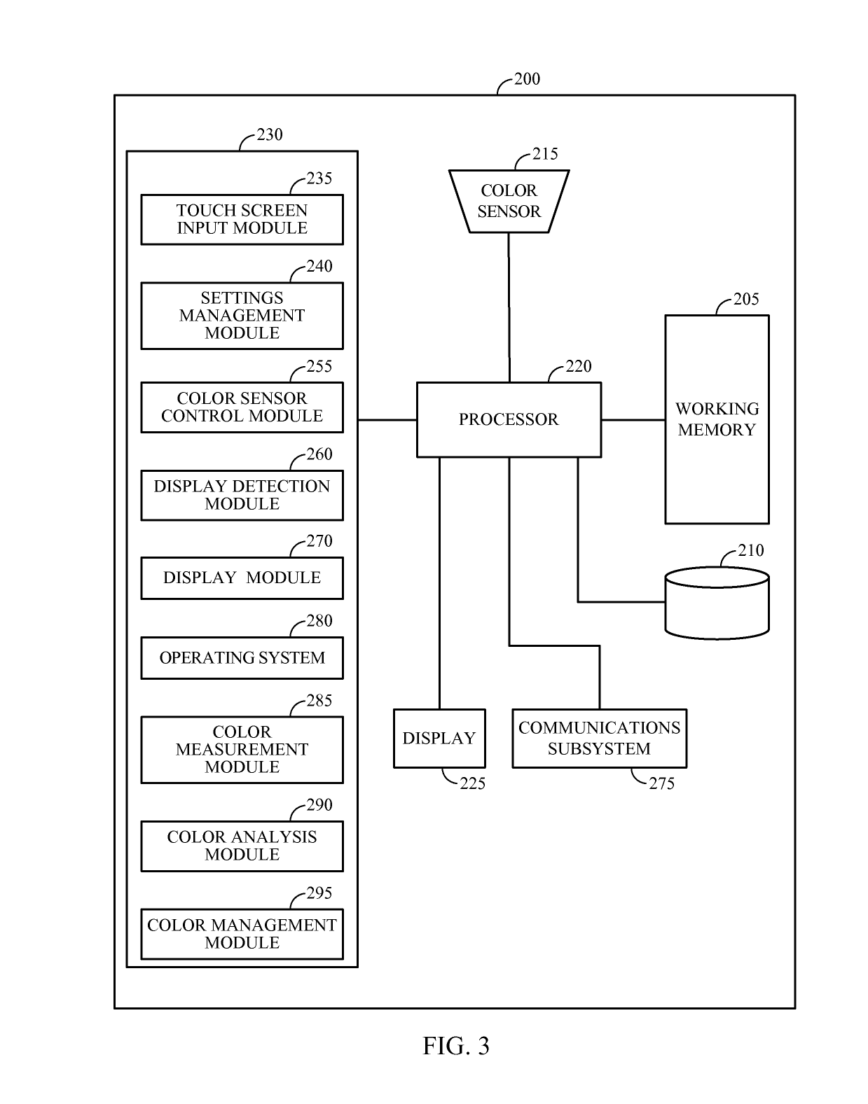

FIG. 3 shows a block diagram of an example of an embodiment of the mobile device 200. In this embodiments, the device 200 has a set of components including a processor 220 linked to a color sensor 215. A working memory 205, storage 210, electronic display 225, memory 230 and a communications subsystem 275 may also be included in the mobile device 200 and in data communication with the processor 220.

The device 200 may be a cell phone, tablet, personal digital assistant, or the like. A plurality of applications may be available to the user on device 200. These applications may relate to color sensing, detecting, and/or measuring, as well as any other applications known in the art.

In the example illustrated in FIG. 3, the processor 220 may be a general purpose processing unit or a processor specially designed for color sensing applications. As shown, the processor 220 is connected to a memory 230 and a working memory 205. In the illustrated embodiment, the memory 230 stores touch screen input module 235, settings management module 240, color sensor control module 255, display detection module 260, display module 270, operating system 280, color measurement module 285, color analysis module 290 and color management module 295. These modules include instructions that configure the processor 220 to perform various image processing and device management tasks. Working memory 205 may be used by processor 220 to store a working set of processor instructions contained in the modules of memory 230. Alternatively, working memory 205 may also be used by processor 220 to store dynamic data created during the operation of the device 200.

The communications subsystem 275 may be a wireless or wired system that allows for communication with other devices. The subsystem 275 may be a transmitter and receiver, or transceiver. It may also be a port, jack or other plug for inserting a cable to connect to another device. In some embodiments, the device 200 connects wirelessly to another device, such as the target device 300. In some embodiments, the subsystem 275 provides for radio, LAN, network and other connections. The communications subsystem 275 may be instructed by the processor 220 to connect and communicate with the other device. Such instructions may be provided to the processor 220 from, for example, the color management module 295.

Still referring to FIG. 3, the processor 220 may be configured by several modules. Touch screen input module 235 may include instructions that configure the processor 220 to receive touch inputs from a touch screen display, for example, display 225. In some embodiments, the display may include two or more displays. Some embodiments may include other types of user interfaces (for example, buttons, dials, switches, keypad, touch pad) instead of or in addition to the touch screen. Settings management module 240 may include instructions to manage various parameter settings for device 200. For example, parameters related to the operation and/or configuration of the color sensor 215 may be managed by module 240. The color sensor control module 255 may include instructions that configure the processor 220 to adjust the color sensor 215, such as its optical configuration. The color sensor control module 255 may also include instructions that configure the processor 220 for certain functionality, including to measure or otherwise sense and/or capture colors with color sensor 215. The display detection module 260 provides instructions that configure the processor 220 to detect an object of interest. In some embodiments, an object of interest may be a digital display screen on a device, such as the display screen 325 on the target device 300. In some embodiments, an object of interest may be a position reference, such as a bright spot displayed at the center of the display 325 of the target device 300, to ensure that the color sensor 215 is properly positioned before measuring colors. Therefore, processor 220, color sensor control module 255, color sensor 215, display detection module 260 and working memory 205 represent one example of an embodiment of measuring a color, such as that of a test pattern on another device, using a color sensor.

Display module 270 may include instructions to manage the display 225. The display module 270 may contain a display architecture that manages and processes data to be displayed on the display 225. The display module 270 may further provide instructions for the processor 220 to identify and/or analyze the display architecture of another device. For example, the display module 270 may provide instructions that configure the processor 220 to identify whether another device is compatible with, and/or to identify the components of, the display architecture of another device. In some embodiments, the instructions may configure the processor 220 to direct the communications subsystem 275 to communicate with another device, such as the target device 300, to establish compatibility and to identify the display architecture of the target device 300. In some embodiments, the display module 270 calls up the settings management module for instructions that configure the processor 220 to retrieve calibration information related to the display architecture of another device. Finally, the display module 270 may further include instructions to manage the layout of data, for instance within a preview window generated on display 225 within device 200.

In the example illustrated in FIG. 3, color measurement module 285 may include instructions that configure the processor 220 to measure color with the color sensor 215. For example, a display on a target device may be recognized, and the contents shown on the display may be measured by the color sensor 215. The color analysis module 290 may include instructions that configure the processor 220 to analyze the measured colors. Color management module 295 may configure the processor 220 to generate color management data for managing the sensed and analyzed color. For instance, adjustments to the sensed color may be generated. The color management module 295 may further configure the processor 220 to generate and then communicate these adjustments via the communications subsystem 275 to another device. For instance, necessary adjustments to bring a color displayed by a target device into compliance with a standard or reference may be generated and communicated.

The various modules may further call subroutines in other modules. For example, the color measurement module 285 may call subroutines in the color sensor control module 255 to configure the processor 220 to sense the colors on a display. Color analysis module 290 may then call subroutines in display detection module 260 to detect displays or colors sensed by the color sensor 215. Instructions in color management module 295 may then invoke settings management module 240 to determine how the user has configured the display module 270 to display data on display 225. Display module 270 may invoke instructions in operating system 280 to control the display and cause it to display the appropriate data configuration on electronic display 225. The color analysis module 290 and/or color management module 295 may further provide instructions that configure the processor 220 to communicate with storage 210 or other memories to retrieve color management information. For example, information specific to a particular test, such as a reference color pattern, may be accessed from the storage 210 or from an external database. The processor 220 may thus instruct the communications subsystem 275 to communicate with the database to retrieve the necessary information.

Operating system module 280 configures the processor 220 to manage the memory and processing resources of device 200. For example, operating system module 280 may include device drivers to manage hardware resources such as the electronic display 225, storage 210, communications subsystem 275 or color sensor 215. Therefore, in some embodiments, instructions contained in the other modules discussed above may not interact with these hardware resources directly, but instead interact through standard subroutines or APIs located in the operating system component 280. Instructions within operating system 280 may then interact directly with these hardware components.

Processor 220 may write data to storage module 210. While storage module 210 is represented graphically as a traditional disk device, those with skill in the art would understand multiple embodiments could include either a disk based storage device or one of several other type storage mediums to include a memory disk, USB drive, flash drive, remotely connected storage medium, virtual disk driver, or the like.

Although FIG. 3 depicts a device comprising separate components to include a processor, color sensor, communications subsystem and memory, one skilled in the art would recognize that these separate components may be combined in a variety of ways to achieve particular design objectives. For example, in an alternative embodiment, the memory components may be combined with processor components to save cost and improve performance.

Additionally, although FIG. 3 illustrates two memory components, to include memory component 230 comprising several modules, and a separate memory 205 comprising a working memory, one with skill in the art would recognize several embodiments utilizing different memory architectures. For example, a design may utilize ROM or static RAM memory for the storage of processor instructions implementing the modules contained in memory 230. Alternatively, processor instructions may be read at system startup from a disk storage device that is integrated into device 200 or connected via an external device port. The processor instructions may then be loaded into RAM to facilitate execution by the processor. For example, working memory 205 may be a RAM memory, with instructions loaded into working memory 205 before execution by the processor 220.

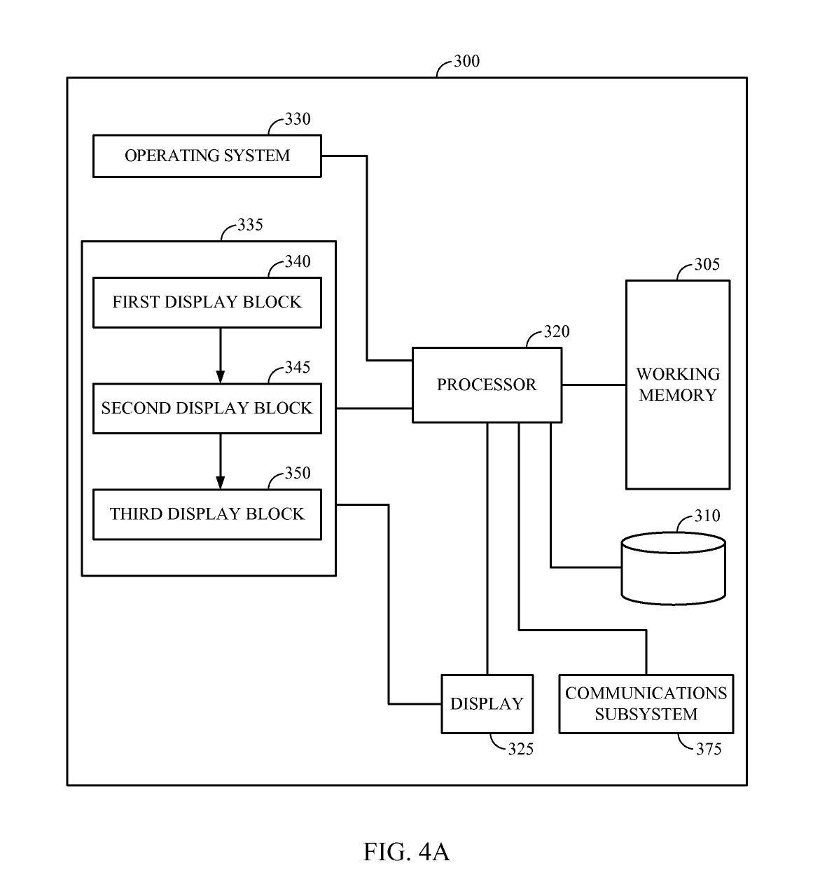

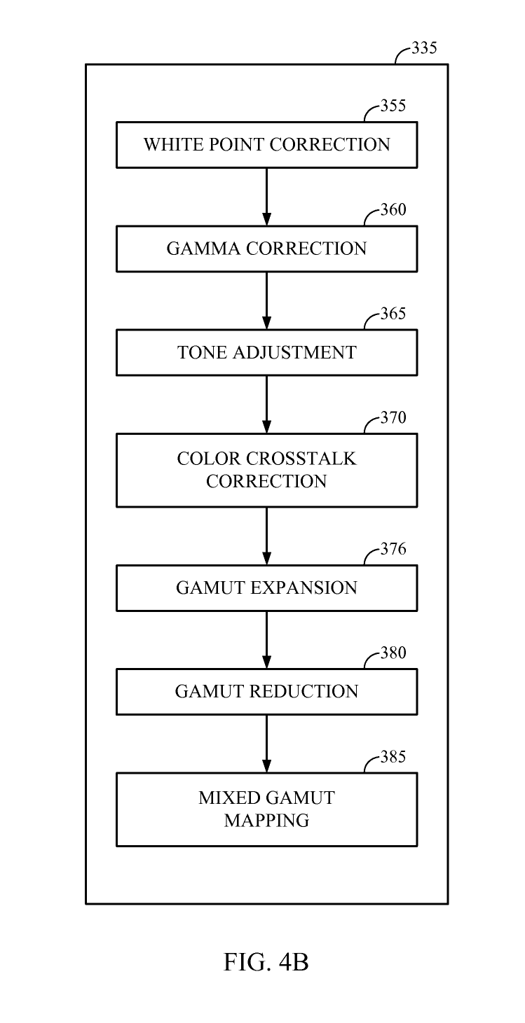

FIG. 4A shows a block diagram of an example of an embodiment of the target device 300 having a display architecture 335. The target device 300 may be, for example, the tablet, mobile or cellular phone illustrated in FIGS. 1A-2B. It may further be any device with a digital display and compatible display architecture.

The target device 300 includes processor 320 linked to display processing pipe architecture 335 and communications subsystem 375. An operating system 330, working memory 305, storage 310, communications subsystem 375 and electronic display 325 are also in data communication with the processor 320. The operating system 330, working memory 305, storage 310, communications subsystem 375 and electronic display 325 may have similar features and functionalities as the operating system 280, working memory 205, storage 210, communications subsystem 275 and electronic display 225 discussed above with respect to mobile device 200. In some embodiments, the target device 300 is the same type of device as mobile device 200. For instance, the target device 300 may include all of the components of the mobile device 200, and vice versa. Therefore, mobile device 200 may also include display architecture 135, and target device 300 may also include color sensor 215. Therefore, the discussion of some features or functionalities with respect to one device is not meant to preclude or limit the features or functionalities of the other device. In some embodiments, the mobile device 200 and the target device 300 are two instances of the same device. In some embodiments, the mobile device 200 and the target device 300 are two instances of the same device where one of them has older or newer software. In some embodiments, regardless of the type of device, the target device 300 has a display architecture that is recognizable and configurable by the mobile device 200.

The operating system 330 of target device 300 may provide instructions that configure the processor 320 to connect and communicate with another device, such as the mobile device 200. In some embodiments, the operating system 330 provides instructions that configure the processor 320 to instruct the communications subsystem 375 to transmit and receive communications to and from another mobile device. The operating system 330 may further provide instructions that configure the processor 320 to retrieve data from the display architecture 335 and have it transmitted via the communications subsystem 375 to another device. The operating system 330 may also provide instructions that configure the processor 320 to send data to the display architecture 335 and that was received via the communications subsystem 375 from another device. In some embodiments, the operating system 330, the communications subsystem 375, and processor 320 allow the target device 300 to connect with the mobile device 200 via the communication connection 120, which may be wireless.

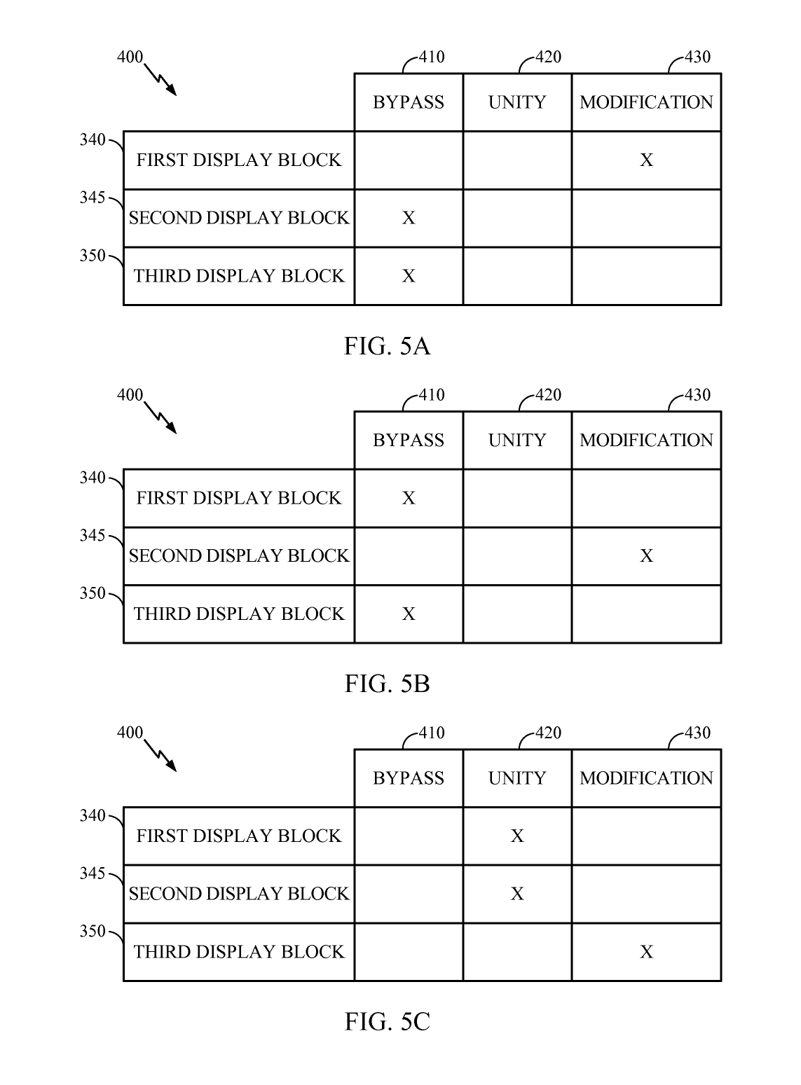

The display architecture 335 includes various blocks or components related to the processing and displaying of display information or other image data on the display 325 of the target device 300. As shown, the display architecture 335 includes a first display block 340, a second display block 345, and a third display block 350. In some embodiments, the architecture 335 includes more blocks. The operating system 330 may provide instructions that configure the processor 320 to send display information to the architecture 335. The display information may be stored locally in storage 310 or retrieved remotely, for example from a remote database using the communications subsystem 375. The operating system 330 may further provide instructions that configure the processor 320 to configure the architecture 335. For instance, the blocks of the architecture 335 may be set to each be in different modes related to actions taken or not taken by the block when display information is processed through the architecture pipeline. In some embodiments, each block of the architecture 335 may be set to a bypass mode, a unity mode, or a program mode, as is discussed in further detail herein, for example with respect to FIGS. 5A-5C. The operating system 330 may further provide instructions that configure the processor 320 to transmit the display information to the architecture 335. The architecture blocks 340, 345 and 350 may be accessed by the processor in sequence or individually. For instance, the operating system 330 may provide instructions that configure the processor 320 and/or architecture 335 to transmit the display information to the first display block 340, and then to the second display block 345, and finally to the third display block 350. In some embodiments, the display information is transmitted only to blocks of the architecture 335 that are set to a particular mode, for instance the program mode. The architecture 335 may provide instructions to the processor 320 to send the display information, after processing by the architecture 335 or portions thereof, to the display 325. In some embodiments, the display information is altered by the display architecture 335 and the altered display information is shown on the screen of the display 325.

FIG. 4B shows a block diagram of an example of an embodiment of the display processing pipe architecture 335 of the target device 300. The architecture 335 of any particular target device 300 may contain one or more of the various illustrated blocks (or components) 355, 360, 365, 370, 376, 380, 385 related to processing of display information to be displayed on the display 325. The “display information” may include the actual pixel information to be displayed and/or information that is used to display the pixel information. The blocks may be part of the architecture 335 in target device 300 as shown in FIG. 4A. Display information, corresponding to a standard or reference associated with each block's respective processing, is sent to that respective block for processing, display, sensing and analysis in order to generate the appropriate adjustments in the form of color management data. The architecture may include white point correction block 355, gamma correction block 360, tone adjustment block 365, color crosstalk correction block 370, gamut expansion block 376, gamut reduction block 380, and mixed gamut mapping block 385. The architecture 335 or operating system 330 may provide instructions that configure the processor 320 to process display information through the display architecture 335. In some embodiments, the processor 320 is configured to configure the architecture 335. In some embodiments, the architecture 335 is configured by having each block in the architecture set to a particular mode. For instance, block 355 may be set to a “program” mode, block 360 may be set to a “unity” mode, and the remaining blocks may be set to a “bypass” mode. This is just one example of the possible arrangement or configuration for the various blocks of the architecture, and others are possible. In this example configuration, the display information may be sent through the architecture 335, where block 355 will be programmed by the display data and the remaining blocks will not be affected, as is discussed in further detail herein, for example with respect to FIGS. 5A-5C. In various operations or modes, one or more of the blocks may be used.

White point correction block 355 may process display information related to white point. A white point, or reference white or target white, is a set of tristimulus values, for example, XYZ or xyz color coordinates that serve to define the color “white.” in image capture, encoding, and/or reproduction. A white pattern may be displayed by the target device 300 and then measured by the color sensor 215 of the mobile device 200 and represented by color coordinates. In some embodiments, the display is eight bit and the RGB space has 255 colors. In some embodiments, the color coordinates are XYZ or chromaticity coordinates xy. The chromaticity coordinates xy may be referred to as the native white chromaticity coordinates for the display screen 325 of the target device 300. The measured chromaticity coordinates, for example xy, may be used to determine how far off the displayed white pattern is from the desired white pattern as set by the desired or target white point. In some embodiments, the white point correction block 335 processes the data to determine what adjustments, if any, are needed to block 355 to correct for white point. In some embodiments, the white point correction block 355 is set to the “modification” mode and the resulting displayed image or images on the screen display 325 of the target device 300 are measured and analyzed by the mobile device 200. These measurements and analyses may then be used to generate color management data that is sent back to the target device 300 and is used to program, modify, or otherwise adjust the white point correction block 355.

The gamma correction block 360 may process display information related to gamma. Gamma correction may be a nonlinear operation used to adjust tone response on each of the RGB channels separately in the display architecture 335 of the target device 300. In some embodiments, the display screen 325 is required to have certain desired or target gamma on all of the RGB channels. The mobile device 200 may communicate with the target device 300 so that the target device 300 displays a set of test patterns for each of the RGB channels. For example, sixty-four (64) monochromatic red test patterns may be used for red channel with levels from 0, 4, 8, . . . , 251, 255. The mobile device 200 may then measure each displayed test pattern using the color sensor 215. The color analysis module 290 may then process the measured data and establish the difference between the desired or target gamma and the measurement data for each RGB channel. This gamma correction data for all three channels may be included in the color management data that is used to modify the gamma correction block 360.

For additional tone adjustment as defined by a user, tone adjustment block 365 is used. For example, if it is desired to have more contrast in an image, an adjustment to gamma may be performed, for example, an additional gamma 1.15 can be used and thus the tone adjustment block 365 is programmed accordingly. Color analysis module 290 may generate the required tone adjustment data and device 200 may upload the data on to the tone adjustment block 365.

Color crosstalk correction block 370 may process display information related to color correction and RGB color crosstalk. A set of standard or reference patterns for color correction and RGB color crosstalk correction may be generated on the fly on the target device 300 by sending a set of signals from mobile device 200 to the target device 300. These patterns may then be sent through the display architecture 335. The color sensor 215 of the mobile device 200 may measure all displayed patterns on the display screen 325 of the target device 300, and through processing may generate color correction/RGB-color-crosstalk correction data. Such data may be included in the color management data that is sent to the target device 300. The target device 300 may then upload this correction data on to the color crosstalk correction block 370. In some embodiments, the RGB color crosstalk block 370 is set to the “bypass” or “unity” mode and the resulting displayed image or images are measured and analyzed by the mobile device 200. These measurements and analyses are used to generate color management data that is sent back to the target device 300 and used to program, modify, or otherwise adjust the color crosstalk block 370.

Gamut expansion block 376 may process display information related to gamut expansion. When the display color gamut is significantly larger than the content color gamut, gamut expansion is required. This process may operate such that when the content colors are displayed on the target device 300, the colors are properly rendered and no color artifacts are generated. A set of standard or reference patterns for display color gamut characterization may be generated on the fly on the display screen 325 of the target device 300 by sending a set of signals from mobile device 200 to the target device 300. These patterns go through the display architecture 335. The color sensor 215 of the mobile device 200 may measure all displayed patterns on the target device 300 and through numerical processing generates gamut expansion data and then uploads this data on to the gamut expansion block 376.

Gamut reduction block 380 may process display information related to gamut reduction. When the display color gamut is significantly smaller than the content color gamut, gamut reduction is required. This process can operate such that when the content colors are displayed on the target device 300 display, they are properly rendered and no color artifacts are generated. A set of standard or reference patterns for display color gamut characterization may be generated on the fly on the display screen 325 of the target device 300 by sending a set of signals from the mobile device 200 to the target device 300. These patterns go through the display architecture 335. The color sensor 215 of the mobile device 200 measures all displayed patterns on the target device 300 and through numerical processing generates gamut reduction data and then uploads these data on to the gamut reduction block 380.

Mixed gamut mapping block 385 may process display information related to mixed gamut mapping. When there is a need to combine and display contents with significantly different color gamut sizes, mixed color gamut mapping is required. This process guarantees that when the mixed content colors are displayed on the target device 300 display, they are properly rendered and no color artifacts are generated. This type of mapping may be generated in advance and can be retrieved from an external database by target device 200 and then loaded on to the mixed gamut mapping block 385 on the target device 200.

FIGS. 5A-5C illustrate examples of data tables with embodiments of configuration settings 400 that may be used by the mobile device 200 in configuring the display architecture 335 of the target device 300. As mentioned, the various blocks of the display architecture 335 of the target device 300 may be set to different modes. These different modes may be set by settings 400 in the display information sent to or retrieved by the target device 300. In some embodiments, the settings 400 are retrieved by the mobile device 300, either from local or remote memory or storage, and then transmitted to the target device 200 to configure the architecture 335. In some embodiments, the settings 400 may be contained in calibration information. The calibration information may be stored locally by the mobile device 200 or target device 300. In some embodiments, a database is queried to obtain the appropriate settings 400. For example, the mobile device 300 may identify the architecture 335 of a target device 300, and then the database, for instance database 110, may be accessed to retrieve calibration information that contains the settings 400 appropriate for the identified architecture 400.

Different embodiments of the settings 400 of a display architecture 335 having three display blocks are shown in FIGS. 5A-5C. The display blocks include the first display block 340, the second display block 345, and the third display block 350, corresponding to the embodiment of the target device 300 shown in FIG. 4A. In some embodiments, the settings 400 may include modes for the display architecture blocks shown in FIG. 4B. For example, the first display block 340 may be the white point correction block 355, the second display block 345 may be the gamma correction block 360, and the third display block 350 may be the tone adjustment block 365. Still other arrangements and configurations for settings 400, that may or may not include other blocks not explicitly addressed herein, may be used. These various display blocks are shown in the rows of the settings 400. Along the columns of the settings 400 are the various modes.

Each display block may be in one of a number of modes. In some embodiments, the display blocks are in one of three different modes. As shown, the modes may include bypass mode 410, unity mode 420, and modification mode 430. In bypass mode 410, a display architecture block may be skipped over or “bypassed” in the display architecture processing pipeline. Therefore, the display information sent to the architecture 335 for processing may not be addressed by display blocks in bypass mode 410. Bypass mode 410 may thus be used for blocks that are not relevant to or otherwise needed for a particular color management process being performed. For instance, if a white point correction color management process is being performed, then tone adjustment block 365 may be set to bypass mode 410.

In unity mode 420, a display processing pipe architecture block may have its input set to its output in the display processing pipe architecture processing pipeline. Therefore, the display information sent to the architecture 335 for processing may not be altered by display blocks in unity mode 420. Unity mode 420 may be used when a target device 300 default response to display information is desired. For instance, the mobile device 200 may be used to manage the white point correction of the target device 300 by providing display information with white point image data to the architecture 335. Having the white point correction block 355 set to the unity mode 420 will allow the white point image data to be processed and displayed in an unmodified or unmanaged form, as the output from block 365 will be the same as the input. This output may then be sensed, measured, and analyzed by the mobile device 200 to determine appropriate color management data to correct or otherwise adjust the white point of the target device 300.

In modification mode 430, a display processing pipe architecture block may be modified, programmed, or otherwise adjusted. In some embodiments, the block will initially be set to unity mode 420 to determine a current, unmodified output. Color management data may then be generated that provides adjustments or modifications for that block based on the output data resulting from the unity mode 420. This block may then be set to modification mode 430 and the color management data may be sent to the display processing pipe architecture 335 for modification of that block.

FIG. 5A shows an embodiment of settings that may be used to modify the first display block 340. The mode to which each display block is set is indicated by the column with the “X” corresponding to a particular mode. For example, first display block 340 is set to modification mode 430 while the second and third display blocks 345, 350 are set to the bypass mode 410. Therefore, display information sent to the display processing pipe architecture 335 with these settings 400 will modify the first display block 340 but will bypass blocks 345 and 350. In FIG. 5B, first and third display blocks 340 and 350 are set to bypass mode 410 and second display block 345 is set to modification. Thus, display information sent to the display processing pipe architecture 335 with the settings 400 shown in FIG. 5B will modify the second display block 345 but will bypass blocks 340 and 350. Finally, display information sent to the display processing pipe architecture 335 with the settings 400 shown in FIG. 5C will modify the third display block 350, set to modification mode 430, but will produce the same output data as was input to blocks 340 and 345, which are set to unity mode 420. Other configurations and arrangements of settings 400 not explicitly addressed herein may be implemented in the display processing pipe architecture 335. For example, more than one block may be set to modification mode 430. Therefore, the preceding examples are given merely to illustrate certain embodiments and should not be read as limiting the scope of the present disclosure in this regard.

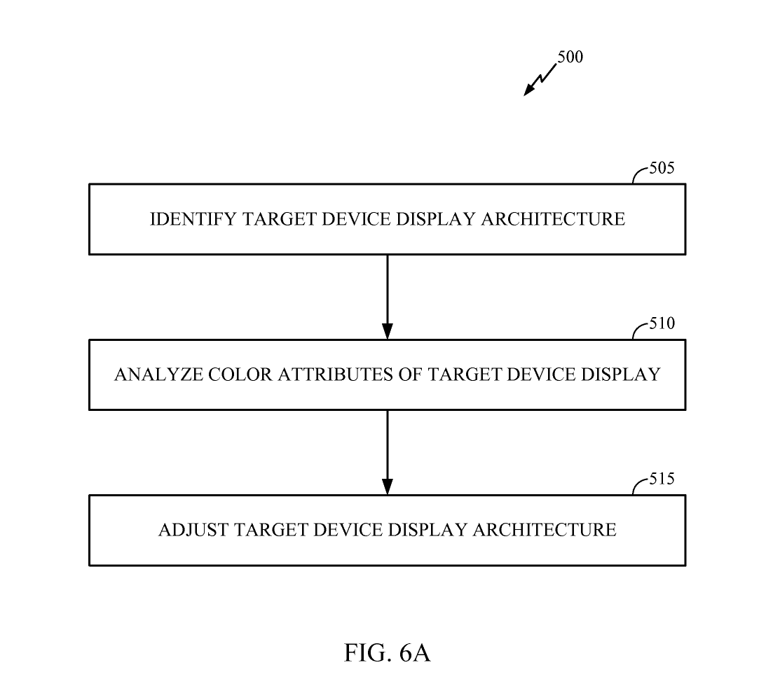

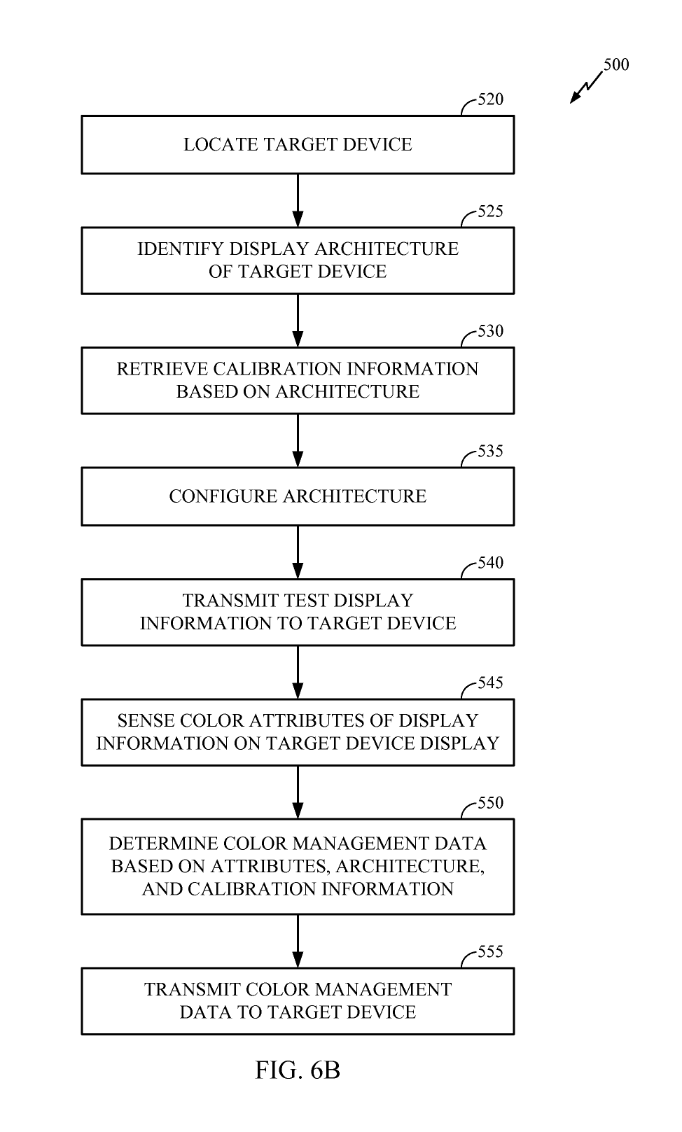

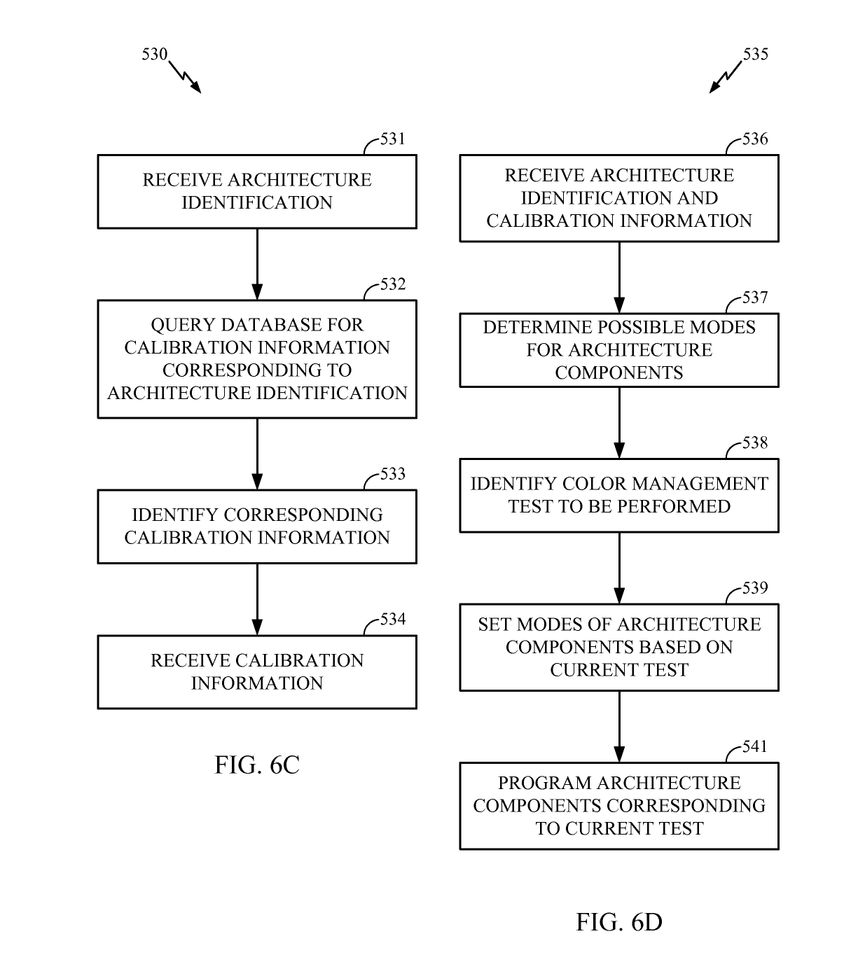

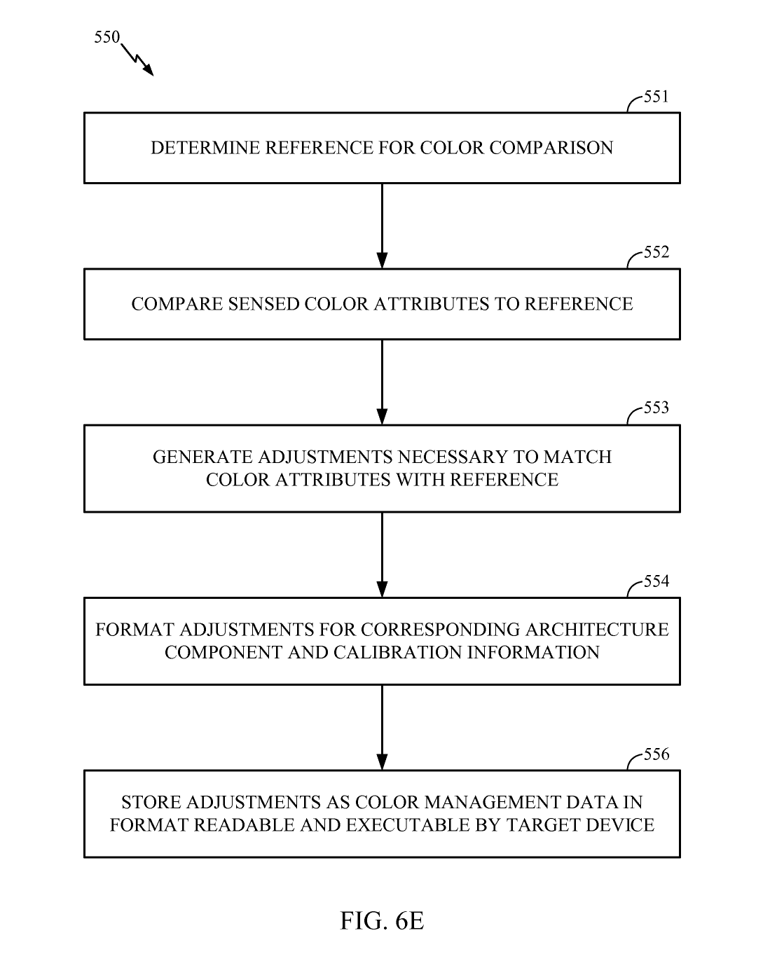

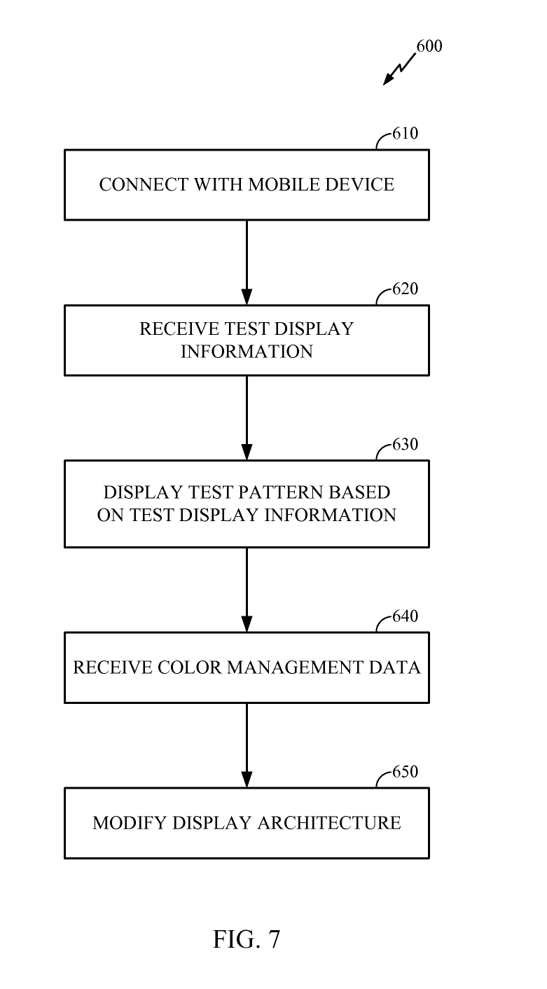

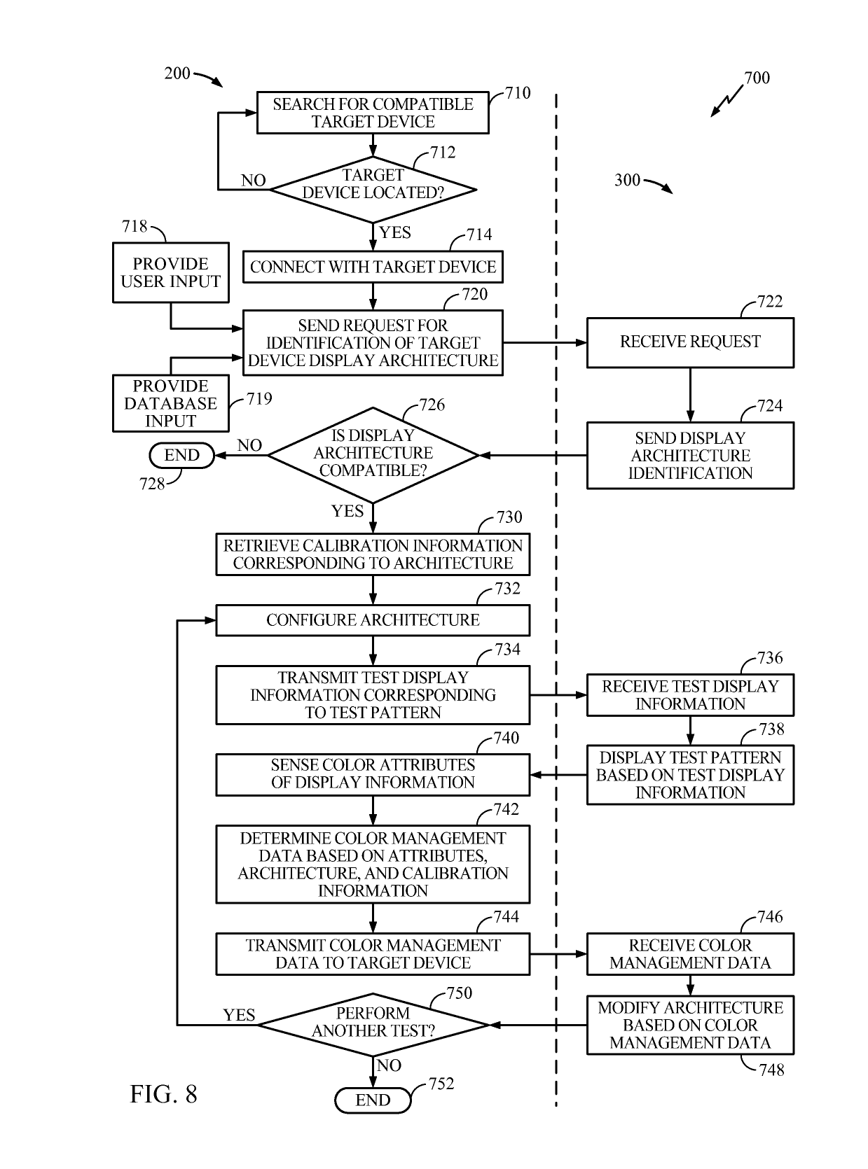

FIG. 6A is a flowchart of an embodiment of a method 500 performed by the mobile device 200 to manage the color of a display screen on the target device 300. The method 500 shown is an overview of the color management process performed by the mobile device 200. The corresponding or complementary processes performed by the target device 300 in managing the color of the target device 300 are discussed herein, for example with respect to FIG. 7. Processes related to the interaction of the mobile device 200 and the target device 300 in managing the color of the target device 300 are also discussed herein, for example with respect to FIG. 8.

As shown in FIG. 6A, the method 500 may begin with block 505 wherein the display architecture of the target device 300 is identified. The architecture may be the display architecture 335. Identification of the architecture may be performed by the mobile device 200, by the target device 300, or a combination thereof. In some embodiments of block 505, the mobile device 200 searches for a compatible target device 300 with which to establish a communication connection. In some embodiments of block 505, the mobile device 200 requests information from the target device 300 regarding the processing blocks and their arrangement in the display architecture of the target device 300. In some embodiments of block 505, the mobile device 200 retrieves calibration information that corresponds to the architecture of the target device 300.

The method 500 then moves to block 510 wherein color attributes of the target device display are analyzed. The target device display may be, for example, the display 325 (FIGS. 1A, 1B). In some embodiments of block 510, the architecture of the target device 300 is configured, for example using the various modes discussed above. In some embodiments of block 510, test display information is transmitted from the mobile device 200 to the target device 300 for display of corresponding patterns on the target device display. In some embodiments of block 510, the color attributes of the patterns as displayed by the target device 300 are sensed by the mobile device 200. In some embodiments of block 510, color management data is generated based on the sensed color attributes, the architecture, and the calibration information. In some embodiments, the color management data includes information corresponding to adjustments to be made to the architecture of the target device 300.

The method 500 then moves to block 515 wherein the display processing blocks of the target device 300 are adjusted or otherwise programmed. In some embodiments, the color management data is transmitted from the mobile device 200 to the target device 300. In some embodiments, the display architecture of the target device 300 may be adjusted by the target device 300 itself, based on the information contained in or represented by the color management data. In some embodiments, the mobile device 200 adjusts or programs the target device display architecture. In some embodiments, the color management data relates to one or more of white point correction, gamma correction, tone adjustment, color crosstalk correction, gamut expansion, gamut reduction, and/or mixed gamut mapping.

The method 500 may therefore include three general steps relating to, first, identification or association of the mobile device 200 with the target device 300; second, to testing and analyzing the target device display; and, third, to adjusting or managing the color of the target device display based on the tests and analyses. Certain details of this overview method 500 are discussed elsewhere, for example with respect to FIG. 6B.

FIG. 6B illustrates an example of a flowchart of an embodiment of a detailed method 500 performed by the mobile device 200 to manage the color of a display screen on a target device 300. The method may begin with block 520 wherein the target device 300 is located. In some embodiments, the target device 300 is located by the mobile device 200. In some embodiments, the target device 300 is located by having the target device 300 make itself known to the mobile device 200. In some embodiments, the display detection module 260 of the mobile device 200 provides instructions that configure the processor 220 to transmit a search signal using the communications subsystem 275. The communications subsystem 375 of the target device 300 may then receive the signal, and the operating system 330 may provide instructions that configure the processor 320 to transmit a locator signal using the communications subsystem 375. In some embodiments, the target device 300 may respond with compatibility information to establish compatibility between the mobile device 200 and the target device 300. In some embodiments, the target device 300 is located wireles sly. In some embodiments, the target device 300 is wired to the mobile device 200. In some embodiments, the target device 300 is located automatically. In some embodiments, the target device 300 is manually located. For instance, a user of the mobile device 200 may manually enter identifying information into the mobile device 200 that corresponds to the target device 300. In some embodiments of block 520, an application or app is used to facilitate locating the target device 200.

Further, block 520 may include establishing a communication connection between the mobile device 200 and the target device 300, allowing for transfer and exchange of data between the devices. In some embodiments, the communication connection is established by wireless connection, such as Bluetooth, LAN, WiFi, or the internet. In some embodiments, the communication connection is established by wired connection, such as by USB cord or the like.

Further, block 520 may include identifying the display of the target device 300 and/or portions thereof. For example, the display detection module 260 of the mobile device 200 may provide instructions that configure the processor 220 to locate the target device display in the field of view of the color sensor 215. In some embodiments, a notification is displayed on the display 225 of the target device 200 when a target device display is located. In some embodiments, the color sensor 215 of mobile device 200 is aligned with or otherwise positioned based on the display center of the display screen 325 of the target device 300. Proper alignment and/or positioning can be achieved by using an alignment pattern displayed on the display screen 325. For example, the alignment pattern may be dark or a darker color (for example, black) except the center area which may be light or a lighter color (for example, white). The color sensor of the mobile device 200 may be moved around until it detects a very bright spot on the target device 300 display.

The method 500 next moves to block 525 wherein the display architecture of the target device 300 is identified. The architecture may be the display architecture 335. Identification of the architecture may be performed by the mobile device 200, by the target device 300, or a combination thereof. In some embodiments of block 505, the mobile device 200 requests information from the target device 300 regarding the display architecture processing pipeline of the target device 300. For instance, the display detection module 260 may provide instructions that configure the processor 220 to send such a request with the communications subsystem 275. The communications subsystem 275 may further be configured to receive data corresponding to the identity of the architecture of the target device 300. For instance, the number, type, and/or arrangement of the display blocks in the architecture may be received.

The method 500 may then move to block 530 wherein the mobile device 200 retrieves calibration information that corresponds to the display architecture of the target device 300. In some embodiments, the calibration information is retrieved locally from memory. For instance, the color measurement module 285 may provide instructions that configure the processor 220 to access or query the storage 210 for calibration information based on the identified architecture. In some embodiments, the calibration information is retrieved remotely. For instance, the color measurement module 285 may provide instructions that configure the processor 220 to access or query the remote database 110 for calibration information based on the identified architecture. In some embodiments, the calibration information may relate to the status of the architecture. For example, the calibration information may relate to the current version of software used by the target device 300 for its display architecture. The calibration information may also relate to the color management compatibility of the mobile device 300 with the target device 200. For instance, the calibration information may relate to the identity of the chip or processing unit of the target device 300. Further detail of block 530 is discussed herein, for example with respect to FIG. 6C.

The method 500 may then move to block 535 wherein the display architecture of the target device 300 is configured. The architecture may be configured by ascribing one of various modes to each block in the architecture. For instance, the target device 300 may include the first, second, and third display blocks 340, 345, 350. The configuration shown, for example in settings 400 in FIG. 5A, may then be applied, wherein the first display block 340 is set to “modification” mode, and the second and third display blocks 345, 350 are set to “bypass” mode. This may be accomplished, for example, by the display module 270 providing instructions that configure the processor 220 to send the desired settings 400 to the target device 300 by transmission with the communications subsystem 275. In some embodiments, the target device 300 will receive the desired settings and configure its own architecture according to the settings. In some embodiments, the mobile device 200 will directly access and configure the architecture of the target device 300. Further detail of block 535 is discussed herein, for example with respect to FIG. 6D.

The method 500 may then move to block 540 wherein test display information is transmitted to the target device 300. In some embodiments, the test display information corresponds to test patterns or other test images to display on the target device 300. In some embodiments, the test display information is identified based on the architecture of the target device 300. For instance, the architecture may include first and third display blocks 340, 350 but not the second display block 345. Thus, for this arrangement, test display information corresponding to the first and third display blocks 340, 350 but not the second display block 345 may be transmitted. In some embodiments, the test display information is identified based on the current test to be performed. For instance, the current test may be a white point correction test. Thus, for this test, the test display information may be information relating to patterns to test the white point of the target device 300. In some embodiments, the display module 270 provides instructions that configure the processor 220 to identify the test display information corresponding to the identified architecture and/or current test.

In block 540, the desired test display information may be retrieved from a variety of sources. In some embodiments, the test display information is retrieved from local memory, such as storage 210. In some embodiments, the test display information is retrieved from a remote database, such as database 110. For example, the display module 270 may provide instructions that configure the processor 220 to access or query the storage 210 or the remote database 110 by using the communications subsystem 275. In other embodiments, the test display information is retrieved from the target device 300. For instance, the target device 300 may retrieve test display information locally or remotely. The target device 300 may then provide the test display information to the mobile device 200, or the target device 300 may use it in other steps of method 500 without providing it to the mobile device 300. In some embodiments, test patterns are solid single color patterns which can be defined by a set of RGB values. The mobile device 200 can send the RGB values of each test pattern as test display information to the target device 300, and the target device 300 can then generate and display the test pattern on the fly dynamically using its display processing blocks.

The test display information may be sent in block 540 from the mobile device 200 to the target device 300. For instance, the color measurement module 285 may provide instructions that configure the processor 220 to retrieve the test display information from storage 210 and transmit it wirelessly through the communications subsystem 275 to the target device 300. In some embodiments, the information is retrieved by the target device 300. For example, the target device 300 may retrieve the test display information from its local memory, or from a remote database.

The method 500 may then move to block 545 wherein color attributes of the target device display are sensed or otherwise measured. The attributes may be the patterns or images that are displayed on the target device 300 and that correspond to the test display information for the current test. For instance, the color measurement module 285 may provide instructions that configure the processor 220 to sense the target device display using the color sensor 215. The colors may be sensed by the color sensor 215 and converted to digital data for analysis by the processor after being configured with instructions provided by color analysis module 690.

The color attributes in block 545 may correspond to one or more color characteristics. In some embodiments, the color attributes correspond to one or more of characteristics related to white point correction, gamma correction, tone adjustment, color crosstalk correction, gamut expansion, gamut reduction, and/or mixed gamut mapping. The color attributes may be from a portion, portions, or substantially all of the target device display.

The method 500 then moves to block 550 wherein color management data is determined or otherwise generated. In some embodiments, the color management data corresponds to adjustments or modifications to be made to the target device display architecture to bring it into compliance with some standard or reference. For instance, the color analysis module 290 may provide instructions that configure the processor 220 to compare the sensed color attributes to a standard or reference. Then, for example, the color analysis management module 295 may provide instructions that configure the processor 220 to generate appropriate adjustments, such as correction data, to the architecture based on the comparison. In some embodiments, the color management data is based on the color attributes, the architecture, and/or the calibration information. Regarding calibration information, the color management data may be formatted to be compatible with the calibration information, such as the current version of software or the processing unit in the target device 300. For instance, the color management module 295 may provide instructions that configure the processor 220 to reformat the color management data based on the calibration information. Further detail of block 550 is discussed herein, for example with respect to FIG. 6E.

The method 500 then moves to block 555 wherein the color management data is transmitted to the target device 300. In some embodiments, the color management data is transmitted wirelessly from the mobile device 200 to the target device 300. For instance, the settings management module 240 may provide instructions that configure the processor 220 to send the color management data to the target device 300 using the communications subsystem 275. In some embodiments, the communication connection established earlier may be used to send the color management data. For instance, the mobile device 200 may transmit the color management data to the target device 300 over the network 105. In some embodiments, the color management data is transmitted from the mobile device 200 to the target device 300 by wire, such as by USB cable or the like.

The various steps of method 500 described above may contain other detailed steps or sub-steps not explicitly discussed herein. FIGS. 5C-5E depict detailed blocks that may be a part of certain blocks in method 500. Referring to FIG. 6C, a flowchart is shown of an embodiment of a detailed method of block 530 for retrieving calibration information. The block 530 may begin with sub-block 531 wherein the architecture identification is received. The block 530 may then move to sub-block 532 wherein a database is queried for calibration information corresponding to the identified architecture. Next, in sub-block 533, corresponding calibration information may be identified. Finally, in sub-block 534, the calibration information may be received.

Referring to FIG. 6D, a flowchart is shown of an embodiment of a detailed method of block 535 for configuring the display architecture. The block 535 may begin with sub-block 536 wherein the architecture identification and calibration information is received. The block 535 may then move to sub-block 537 wherein the possible modes for the architecture components are determined. Block 535 may then move to sub-block 538 wherein the color management test to be performed is identified. Next, block 535 may move to sub-block 539 wherein the architecture components or blocks corresponding to the current test are programmed or otherwise modified.

Referring to FIG. 6E, a flowchart is shown of an embodiment of a detailed method of block 550 for determining and generating color management data. Block 550 may begin with sub-block 551 wherein a reference or standard is determined for color comparison. In some embodiments, a red-green-blue (RGB) color space is used as the standard. The RGB color space may be any additive color space based on the RGB color model. The particular RGB color space for a particular test may be defined by the chromaticity of the three red, green, and blue additive primaries, and can produce any chromaticity that is the triangle defined by those primary colors. The complete specification of an RGB color space may also require a white point chromaticity and a gamma correction curve. In some embodiments, sRGB may be used as the reference or standard. sRGB may be a standard RGB color space that uses the ITU-R BT.709 primaries, the same as are used in studio monitors and high definition television (HDTV), and a transfer function (gamma curve) typical of CRTs. Unlike most other RGB color spaces, the sRGB gamma cannot be expressed as a single numerical value. The overall gamma is approximately 2.2, consisting of a linear (gamma 1.0) section near black, and a non-linear section elsewhere involving a 2.4 exponent and a gamma (slope of log output versus log input) changing from 1.0 through about 2.3. The sRGB color space may be used for consumer grade digital cameras, high definition (HD) video cameras, and computer monitors. HDTVs use a similar space, commonly called Rec. 709, sharing the sRGB primaries. Depending on the application, any of these or other references or standards may be employed in sub-block 551 of block 550.

Next, in sub-block 552, the sensed color attributes may be compared to the reference or standard. Block 550 may then move to sub-block 553 wherein the adjustments or modifications to the architecture that are necessary to match, or more closely match, the color attributes to the reference are generated. In some embodiments, the various display processing blocks in the target device 300 are programmed based on the generated calibration/correction data. Block 550 may continue with sub-block 554 wherein the generated adjustments or modifications are formatted to correspond to, or otherwise be compatible with, the appropriate architecture component(s) or block(s) involved in the current test and with the retrieved calibration information. Finally, in sub-block 556, the adjustments may be converted and/or stored as color management data in a format that is readable and/or executable by the target device 300.

FIG. 7 is a flowchart of an embodiment of a method 600 performed by the target device to program or otherwise modify the target device display architecture. Method 600 may begin with block 610 wherein a connection with the mobile device 200 is established. The connection may be established in any of the manners described elsewhere herein. For instance, the connection may be established wirelessly or by wired connection, and may be over Bluetooth, LAN, WiFi, the internet, USB cable, etc. In some embodiments, the operating system 330 of target device 300 provides instructions that configure the processor 320 to establish the connection using the communication subsystem 375. In some embodiments, the processor 320 is configured by the operating system 330 to automatically establish a connection with the mobile device 200. In some embodiments, the processor is manually configured by a user to establish the connection, for example by receiving inputs from a user identifying the mobile device 300.

The method 600 may then move to block 620 wherein test display information is received. In some embodiments, the test display information is received from the mobile device 300. For instance, the operating system 330 may provide instructions that configure the processor 320 to receive test display information using the communications subsystem 375. In some embodiments, the test display information is received by retrieving it from the local memory in the target device 300. For instance, the operating system 330 may provide instructions that configure the processor 320 to access the desired test display information from storage 310. In some embodiments, the test display information is received by retrieving it from a remote database. For instance, the operating system 330 may provide instructions that configure the processor 320 to access the remote database 110, either directly or indirectly through the network 105, and retrieve from it the desired test display information. In some embodiments, the test display information is formatted in block 620 so as to be compatible with the target device 300.

Block 620 may further include configuring the architecture of the target device 300. In some embodiments, the architecture is configured based on the current test being performed. For instance, a white point correction test may require that the white point correction block 355 of the architecture 335 is set to “modification” mode 430. In some embodiments, the target device 300 performs steps to configure the architecture 335. For instance, the operating system 330 may provide instructions that configure the processor 320 to apply the modification mode 430 to block 355, and to set all other blocks in the architecture 335 to either bypass mode 410 or unity mode 420.

The method 600 may then move to block 630 wherein a test pattern or patterns are displayed, on the display screen of the target device 300, that correspond to the received test display information. For example, the operating system 330 may provide instructions that configure the processor 320 to display on the display screen 325 the pattern or image corresponding to the test display information. The operating system 330 may further provide instructions that configure the processor 320 to retrieve, either locally or remotely, the pattern or image corresponding to the test display information. In some embodiments, the test display information is sent through the display architecture 335 of the target device 300 en route to being displayed on the display screen 325. For example, the operating system 230 may provide instructions that configure the processor 320 to process the received test display information through the architecture 335. In some embodiments, the test patterns are still images or patterns. In some embodiments, the test patterns are a series of still images or patterns. By images or patterns it is meant to refer to any representation of information, for example, a graphical representation, that may be shown on the display 325 of the target device 300 and sensed by the color sensor 215 of the mobile device 200. This may include, for example, uniform color patterns, mixed color patterns, shades or tints of colors, images of skin tones, etc.

The method 600 may then move to block 640 wherein color management data is received. In some embodiments, the color management data is sent from the mobile device 200 to the target device 300, either directly or indirectly, by wired or wireless connection. For instance, the operating system 330 may provide instructions that configure the processor 320 to wirelessly receive color management data using the communication subsystem 375. In some embodiments, the color management data is formatted or analyzed by the target device 300. For instance, the operating system 330 may provide instructions that configure the processor 320 to retrieve corresponding data from storage 310 that is in a suitable format to be applied to the architecture 335.

The method 600 may then move to block 650 wherein the display architecture of the target device 300 is modified. In some embodiments, the blocks of the architecture that are set to modification mode 430 are modified. For instance, the operating system 330 may provide instructions that configure the processor 320 to apply the modification corresponding to the color management data to the blocks in modification mode 430. For example, the white point correction block 355 may be modified such that the white point is changed. In some embodiments, the display white point CCT (correlated color temperature) is corrected and/or adjusted to a desired or target CCT.

FIG. 8 is a flowchart of an embodiment of a process 700 of managing the color of the target device 300 with the mobile device 200 showing interactions of the methods of FIGS. 5B and 6. The left side of the process 700 as shown may be performed by the mobile device 200, while the right side of the process 700 as shown may be performed by the target device 300. The process 700 may begin with block 710 wherein a search for a compatible target device 300 is performed. The process 700 moves to decision block 712 wherein it is determined whether the target device 300 was located. If the target device 300 is not located, the process 700 moves back to block 710 wherein a search for a compatible target device 300 is performed again. If in decision block 712 the target device 300 is located, then the process 700 moves to block 714 wherein the mobile device 200 and the target device 300 communicatingly connect. Next, in block 720, a request for the identification of the target device display architecture is sent. This may be sent from the mobile device 200 to the target device 300. Further, block 720 may include blocks 718 and 719 wherein, respectively, input is provided from a user and a database to the mobile device 200.

The request for identification of the target device display architecture in block 720 may be sent to the target device 300. In block 722, the request may be received by the target device 300. Next, in block 724, the target device 300 may send the identification of the display architecture to the mobile device 200. This may include, for example, the type, number, and/or arrangement of the components or blocks in the display architecture processing pipeline.

The process 700 may then move to decision block 726 wherein it is determined whether the display architecture is compatible. For instance, the architecture may or may not be recognized or known. If the display architecture is not compatible, then the process 700 moves to block 728 and ends. If the display architecture is compatible, then the process 700 moves to block 730 wherein calibration information corresponding to the architecture is retrieved. Then, in block 732, the architecture of the target device 300 is configured. This may include, for example, determining to which settings 400 of various modes the components or blocks of the architecture should be set. In some embodiments, the configuration is contained in other information sent to the target device 300, such as the test display information sent in the next step. In block 734, test display information corresponding to a particular test pattern or patterns is transmitted to the target device 300.

The target device 300 in block 736 then receives the test display information. This block may include ascribing various modes to one or more components of the display architecture. In the next block 738, the target device 300 displays the test pattern based on the test display information.

The process 700 then moves to block 740 wherein the mobile device 200 senses one or more color attributes of the display information presented by the target device 300. Next, in block 742, the mobile device 200 determines color management data based on the color attributes, the display architecture, and the calibration information. Then in block 744 the color management data is transmitted to the target device 300.

The target device 300 then receives the color management data in block 746. The process then moves to block 748 wherein the display architecture is programmed, configured, or otherwise modified based on the color management data.

The process 700 may then move to decision block 750 wherein the mobile device 200 determines whether to perform another test. If it is determined in decision block 750 that another test is to be performed, then the process 700 moves to block 732 and configures the display architecture according to the new test. If it is determined in decision block 750 that another test is not to be performed, then the process 700 moves to block 752 and ends.

The logical blocks, modules and flow chart sequences are illustrative only. A person of skill in the art will understand that the steps, decisions, and processes embodied in the flowcharts described herein may be performed in an order other than that described herein. Thus, the particular flowcharts and descriptions are not intended to limit the associated processes to being performed in the specific order described.

Those of skill in the art will recognize that the various illustrative logical blocks, modules, and method steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor reads information from, and write information to, the storage medium. In the alternative, the storage medium may be integral to the processor. The processor and the storage medium may reside in an ASIC.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

A person skilled in the art will recognize that each of these sub-systems may be inter-connected and controllably connected using a variety of techniques and hardware and that the present disclosure is not limited to any specific method of connection or connection hardware.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, a microcontroller or microcontroller based system, programmable consumer electronics, network PCs, minicomputers, mainframe computers, distributed computing environments that include any of the above systems or devices, and the like.

As used herein, instructions refer to computer-implemented steps for processing information in the system. Instructions may be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, an Alpha® processor, or a duo core or quad core processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®. The system control may be written in any conventional programming language such as C, C++, BASIC, Pascal, .NET (e.g., C#), or Java, and ran under a conventional operating system. C, C++, BASIC, Pascal, Java, and FORTRAN are industry standard programming languages for which many commercial compilers may be used to create executable code. The system control may also be written using interpreted languages such as Perl, Python or Ruby. Other languages may also be used such as PHP, JavaScript, and the like.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods, devices and systems of the present invention. This invention is susceptible to modifications in the methods, devices and systems. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the following claims. Therefore, although this invention has been disclosed in the context of certain preferred embodiments and examples, it will be understood by those skilled in the art that the present invention extends beyond the specifically disclosed embodiments to other alternative embodiments and/or uses of the invention and equivalents thereof. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A mobile device based system for managing color of a display screen on a target device, the system comprising:
a communications subsystem configured to communicate with the target device;
a color sensor configured to sense one or more color attributes of display information presented on the display screen; and
a processor configured to execute a set of instructions to perform a method comprising
identifying a display architecture of the target device;
sensing the one or more color attributes of display information presented on the display screen;
determining color management data based in part on the one or more color attributes and the identified display architecture of the target device; and
transmitting the color management data to the target device.

2. The system of claim 1, wherein the method further comprises:
configuring the display architecture of the target device.

3. The system of claim 1, wherein determining color management data comprises:
retrieving, from a memory component of the mobile device, calibration information based on the identified display architecture of the target device,
wherein determining the color management data is based in part on the retrieved calibration information.

4. The system of claim 1, wherein the color management data is configured to be received by the target device and to cause the display architecture of the target device to be modified based on the received color management data.

5. The system of claim 1, wherein the method further comprises:
transmitting test display information to the target device from the mobile device,
wherein the test display information indicates at least one test pattern to present on the display screen of the target device.

6. The system of claim 5, wherein the test display information is configured to be received by the target device and to cause the target device to display one or more test patterns on the display screen of the target device, wherein the one or more test patterns are based on the received test display information.

7. The system of claim 1, wherein the one or more color attributes includes information related to white point correction, gamma correction, tone adjustment, color crosstalk correction, gamut expansion, gamut reduction, or mixed gamut mapping.

8. The system of claim 4, wherein modifying the display architecture of the target device comprises:
programming one or more components of the display architecture of the target device using the color management data.

9. The system of claim 8, wherein the one or more components of the display architecture of the target device comprises a white point, gamma, or tone parameter.

10. A mobile device based system for managing color of a display screen on a target device, the system comprising:
means for identifying a display architecture of the target device;
means for sensing one or more color attributes of display information presented on the display screen;
means for determining color management data based in part on the one or more color attributes and the identified display architecture of the target device; and
means for transmitting the color management data to the target device.

11. The system of claim 10, further comprising:
means for configuring the display architecture of the target device.

12. The system of claim 10, wherein the means for determining comprises:
means for retrieving, from a memory component of the mobile device, calibration information based on the identified display architecture of the target device,
wherein determining the color management data is based in part on the retrieved calibration information.

13. The system of claim 10, wherein the color management data is configured to be received by the target device and to cause the display architecture of the target device to be modified based on the received color management data.

14. The system of claim 10, further comprising:
means for transmitting test display information to the target device from the mobile device,
wherein the test display information is configured to be received by the target device and to cause the target device to display one or more test patterns on the display screen of the target device, wherein the one or more test patterns are based on the received test display information.

15. The system of claim 10, wherein the one or more color attributes includes information related to white point correction, gamma correction, tone adjustment, color crosstalk correction, gamut expansion, gamut reduction, or mixed gamut mapping.

16. The system of claim 13, wherein modifying the display architecture of the target device comprises:
programming one or more components of the display architecture of the target device using the color management data.

17. A method of managing color of a display screen on a target device, the method comprising:
identifying, with a mobile device, a display architecture of the target device;
sensing, with the mobile device, one or more color attributes of display information presented on the display screen;
determining, with the mobile device, color management data based in part on the one or more color attributes and the identified display architecture of the target device; and
transmitting the color management data to the target device.

18. The method of claim 17, further comprising:
programming the display architecture of the target device.

19. The method of claim 17, wherein determining comprises:
retrieving, from a memory component of the mobile device, calibration information based on the identified display architecture of the target device,
wherein determining the color management data is based in part on the retrieved calibration information.

20. The method of claim 17, wherein the color management data is configured to be received by the target device and to cause the display architecture of the target device to be programmed based on the received color management data.

21. The method of claim 17, further comprising:
transmitting test display information to the target device from the mobile device,
wherein the test display information indicates at least one test pattern to present on the display screen of the target device.

22. The method of claim 21, wherein the test display information is configured to be received by the target device and to cause the target device to display one or more test patterns on the display screen of the target device, wherein the one or more test patterns are based on the received test display information.

23. The method of claim 17, wherein the one or more color attributes includes information related to white point correction, gamma correction, tone adjustment, color crosstalk correction, gamut expansion, gamut reduction, or mixed gamut mapping.

24. The method of claim 20, wherein modifying the display architecture of the target device comprises:
programming one or more components of the display architecture of the target device using the color management data.

25. A non-transient computer readable medium configured to store instructions that when executed by a processor perform a method for color management of a display screen on a target device, the method comprising:
identifying a display architecture of the target device;
sensing the one or more color attributes of display information presented on the display screen;
determining color management data based in part on the one or more color attributes and the identified display architecture of the target device; and
transmitting the color management data to the target device.

26. The non-transient computer readable medium of claim 25, wherein the method further comprises:
configuring the display architecture of the target device.

27. The non-transient computer readable medium of claim 25, wherein determining comprises:
retrieving, from a memory component of the mobile device, calibration information based on the identified display architecture of the target device,
wherein determining the color management data is based in part on the retrieved calibration information.

28. The non-transient computer readable medium of claim 25, wherein the color management data is configured to be received by the target device and to cause the display architecture of the target device to be modified based on the received color management data.

29. The non-transient computer readable medium of claim 25, wherein the method further comprises:
transmitting test display information to the target device from the mobile device,
wherein the test display information indicates at least one test pattern to present on the display screen of the target device.

30. The non-transient computer readable medium of claim 28, wherein modifying the display architecture of the target device comprises:
programming one or more components of the display architecture of the target device using the color management data.
